(19) United States
(12) Patent Application Publication
(10) Pub. No.: US 2026/0326703 A1
(43) Pub. Date: Oct. 22, 2026

(54) VEHICLE INTERIOR COMPONENT

(71) Applicant: Yanfeng International Automotive Technology Co. Ltd., Novi, MI (US)

(72) Inventors: Liu GONG, Shanghai (CN); Jie SUN, Shanghai (CN); Cheng LIU, Shanghai (CN)

(21) Appl. No.: 19/692,569

(22) Filed: May 29, 2026

Related U.S. Application Data
(63) Continuation-in-part of application No. PCT/CN2024/133686, filed on Nov. 22, 2024.

(30) Foreign Application Priority Data
Nov. 29, 2023 (CN) 202323228266.5

(51) Int. Cl. B60R 21/2165

(52) U.S. Cl. CPC B60R 21/21656

(57) ABSTRACT

A component to facilitate formation of an opening for airbag deployment into a vehicle interior is disclosed. The component comprises a composite structure comprising a cover with base layer and cover layer; the composite structure comprises a line at a weakened area for formation of the opening; the line may comprise a set of features; each feature comprises a profile and/or recess comprising the profile in the cover; the profile may be formed into base layer and/or cover layer; the line may comprise a seam/tear line; the line may comprise groove sections and features. Base layer may comprise a molded/formed substrate; cover layer may be molded/formed on base layer. The cover may provide a surface effect; the line may be visually imperceptible at the cover. The component may comprise a steering wheel assembly and/or trim component; the composite structure may comprise an airbag chute and airbag module comprising the airbag.

### CROSS-REFERENCE TO RELATED APPLICATIONS

The present application is a continuation-in-part of PCT/International Patent Application No. PCT/CN2024/133686 titled “COVER PLATE OF AIRBAG AND VEHICLE STEERING WHEEL” filed Nov. 22, 2024, that claims the benefit of Chinese Patent Application No. 202323228266.5 titled “AIRBAG COVER AND VEHICLE STEERING WHEEL” filed Nov. 29, 2023.

The present application claims priority to and incorporates by reference in full: (1) PCT/International Patent Application No. PCT/CN2024/133686 titled “COVER PLATE OF AIRBAG AND VEHICLE STEERING WHEEL” filed Nov. 22, 2024; and (2) Chinese Patent Application No. 202323228266.5 titled “AIRBAG COVER AND VEHICLE STEERING WHEEL” filed Nov. 29, 2023.

The present application relates to the following patent applications/documents: (a) Chinese Patent Application No. 202010326691.X filed Apr. 23, 2020 (now Chinese Patent No. 111391777B); (b) PCT/International Patent Application No. PCT/CN2021/088929 titled “VEHICLE INTERIOR COMPONENT” filed Apr. 22, 2021; (c) U.S. patent application Ser. No. 17/941,579 titled “COMPONENT FOR VEHICLE INTERIOR” filed Sep. 9, 2022; (d) U.S. patent application Ser. No. 18/825,607 (now U.S. Pat. No. 12,623,624) titled “COMPONENT FOR VEHICLE INTERIOR” filed Sep. 5, 2024; and (e) U.S. patent application Ser. No. 19/464,996 titled “COMPONENT FOR VEHICLE INTERIOR” filed Jan. 30, 2026.

### FIELD

The present application relates a vehicle interior component.

The present application relates to a vehicle interior component configured to facilitate deployment of an airbag into a vehicle interior.

The present application relates to a vehicle interior component comprising a composite structure configured to form an opening to facilitate deployment of an airbag into a vehicle interior.

### BACKGROUND

It is known to provide a vehicle interior component configured to facilitate deployment of an airbag into a vehicle interior.

It would be advantageous to provide an improved vehicle interior component comprising a composite structure configured to form an opening to facilitate deployment of an airbag into a vehicle interior.

It would be advantageous to provide an improved vehicle interior component comprising a composite structure comprising a cover configured to form an opening to facilitate deployment of an airbag into a vehicle interior.

It would be advantageous to provide an improved vehicle interior component comprising a composite structure comprising a cover comprising a base layer and a cover layer configured to form an opening to facilitate deployment of an airbag into a vehicle interior.

### SUMMARY

The present invention relates to a component configured to facilitate formation of an opening for deployment of an airbag into an interior of a vehicle comprising a composite structure comprising a cover comprising a base layer and a cover layer; the composite structure may comprise a line at a weakened area for the cover; the line is configured to facilitate formation of the opening at the weakened area for the cover; the line may comprise a set of features configured to facilitate formation of the opening through the cover; each feature of the set of features may comprise a profile. Each feature may comprise a recess comprising the profile in the cover; the profile of the recess is at least partially formed into the base layer of the cover; the line may comprise a seam and/or a tear line and/or a seam line and/or weakening line and/or a set of sections and/or a set of segments; the line may comprise a set of groove sections and the set of features; each feature of the set of features may comprise a recess adjacent to a groove section of the set of groove sections. The set of features may comprise a pattern of features formed in the cover; the pattern of features is configured to form the line in the cover as a weakening line at the weakened area; the set of features may comprise a pattern of recesses in the cover; the line may comprise a tear line in the cover provided by the pattern of recesses; the set of features may comprise a pattern of recesses formed in the cover; the line may comprise a tear line formed in the cover by the pattern of recesses. The line may comprise a groove in the base layer of the cover; the groove of the line may comprise a profile; the profile of the groove of the line may comprise a U-shaped profile and/or a V-shaped profile and/or a multi-section profile. The profile of a feature of the set of features may comprise a uniform-section profile and/or a multi-section profile and/or a tapered profile and/or a sloped section and/or a tip comprising a point and/or a tip at a closed section and/or a trapezoidal shaped profile and/or a U-shaped profile. Each feature may comprise a recess; the profile of the recess may comprise an open section and a closed section. The profile of each feature may comprise an open section formed into the base layer and a closed section at least partially formed into the base layer; the profile of each feature may comprise an open section formed into the base layer and a closed section at least partially formed into the cover layer. The line may comprise a set of groove sections; a profile of each groove section of the set of groove sections of the line may comprise a shape; the profile of each feature of the set of features of the line may comprise a shape different than the shape of the profile of each groove section of the set of groove sections of the line. The composite structure may comprise a surface layer on the cover layer; the surface layer may comprise a film and/or a coating and/or an applied coating. The base layer may comprise an injection-molded substrate for the cover; the cover layer is formed on the base layer. The cover layer may comprise a molded material formed on the base layer. The feature may comprise a pattern of recesses configured to form the line as a weakening line at the weakened area for the cover; each recess of the pattern of recesses has a generally V-shaped profile formed into the cover to provide the weakening line at the weakened area for the cover. The feature may comprise a set of recesses; the line may comprise a set of groove sections; a recess of the set of recesses is coupled to a groove section of the set of groove sections to provide the line as a weakening line at the weakened area of the cover. The cover may be configured to provide a surface effect at an exterior surface of the cover layer; the surface effect may comprise a tactile effect and/or a texture effect and/or a color effect and/or a visual effect and/or a decorative effect and/or a protective effect and/or a concealment effect with the line generally visually imperceptible at the exterior surface. The component may comprise a steering wheel assembly and/or a trim component and/or a trim panel and or a trim panel for a steering wheel assembly; the composite structure may comprise an airbag chute and an airbag module comprising the airbag.

The present invention relates to a component configured to facilitate formation of an opening for deployment of an airbag into an interior of a vehicle comprising a composite structure comprising a cover comprising a base layer and a cover layer; the composite structure may comprise a line at a weakened area; the line is configured to facilitate formation of the opening at the weakened area; the line may comprise a set of features configured to facilitate formation of the opening; each feature of the set of features may comprise a profile. Each feature may comprise a recess comprising the profile. The line may comprise a seam and/or a tear line and/or a seam line and/or weakening line and/or a set of sections and/or a set of segments. The line may comprise a set of groove sections and the set of features; each feature of the set of features may comprise a recess adjacent to a groove section of the set of groove sections. The set of features may comprise a pattern of features formed in the cover; the pattern of features is configured to form the line in the cover as a weakening line at the weakened area. The set of features may comprise a pattern of recesses in the cover; the line may comprise a tear line in the cover provided by the pattern of recesses. The set of features may comprise a pattern of recesses formed in the cover; the line may comprise a tear line formed in the cover by the pattern of recesses. The line may comprise a groove in the base layer of the cover; the groove of the line may comprise a profile; the profile of the groove of the line may comprise a U-shaped profile and/or a V-shaped profile and/or a multi-section profile. The profile of a feature of the set of features may comprise a uniform-section profile and/or a multi-section profile and/or a tapered profile and/or a sloped section and/or a tip comprising a point and/or a tip at a closed section and/or a trapezoidal shaped profile and/or a U-shaped profile. The profile of the recess may comprise an open section and a closed section. The profile of the recess is at least partially formed into the base layer. The profile of the feature may comprise an open section formed into the base layer and a closed section at least partially formed into the base layer. The profile of the feature may comprise an open section formed into the base layer and a closed section at least partially formed into the cover layer. The line may comprise a set of groove sections; a profile of each groove section of the set of groove sections of the line may comprise a shape; the profile of each feature of the set of features of the line may comprise a shape different than the shape of the profile of each groove section of the set of groove sections of the line. The composite structure may comprise a surface layer on the cover layer; the surface layer may comprise a film and/or a coating and/or an applied coating. The base layer may comprise a substrate for the cover; the cover layer is formed on the base layer. The cover layer may comprise a cover layer material comprising a molded material formed on the base layer. The line may comprise a set of features formed in the base layer and in the cover layer. The feature may comprise a pattern of recesses configured to form the line as a weakening line at the weakened area of the cover; the pattern of recesses may comprise a U-shaped pattern and/or an H-shaped pattern. The feature may comprise a set of recesses; the line may comprise a set of groove sections; a recess of the set of recesses is coupled to a groove section of the set of groove sections to provide the line as a weakening line at the weakened area of the cover. The cover may be configured to provide a surface effect at an exterior surface of the cover layer; the surface effect may comprise a tactile effect and/or a texture effect and/or a color effect and/or a visual effect and/or a decorative effect and/or a protective effect. The cover may be configured to provide a surface effect at an exterior surface of the cover layer; the surface effect may comprise a tactile effect and/or a texture effect and/or a color effect and/or a visual effect and/or a decorative effect and/or a protective effect and/or a concealment effect with the line generally visually imperceptible at the exterior surface. The line may be configured to be generally visually imperceptible at an exterior surface of the cover layer. The component may comprise a steering wheel assembly and/or a trim component and/or a trim panel and or a trim panel for a steering wheel assembly; the composite structure may comprise an airbag chute and an airbag module comprising the airbag. The present invention relates to a component configured to facilitate formation of an opening for deployment of an airbag into an interior of a vehicle may comprise a composite structure comprising a cover comprising a base layer and a cover layer; the composite structure may comprise a line at a weakened area; the line may be configured to facilitate formation of the opening at the weakened area; the line may comprise a feature configured to facilitate formation of the opening; the feature may comprise a recess; the feature may comprise a set of features; the line may comprise the set of features; the set of features may comprise a pattern of features; the line may comprise a tear line; the line may comprise a seam; the line may comprise a set of sections to couple each feature of a set of features; each feature may comprise a profile; the profile may comprise a tapered profile; the profile may comprise a sloped section; the profile may comprise a set of sections; the profile may comprise a set of sections and a tip; the tip may comprise a closed section of the profile; the profile may comprise a trapezoidal shape; the profile may comprise a V-shaped profile; the profile may comprise a U-shaped profile; the profile may comprise a section formed into the cover; the profile may comprise an open section and a closed section formed into the cover; the profile may comprise an open section formed into the base layer of the cover; the profile may comprise a closed section formed into the base layer of the cover; the profile may be partially formed into the cover layer; the profile may comprise the closed section partially formed into the cover layer; the line may comprise a profile; the line may comprise a notch; each section of the line may comprise a profile; the profile of the line may comprise a groove-shaped profile; the profile of the line may comprise a U-shaped profile; the profile of the line may comprise a V-shaped profile; the profile of the line may be formed into the base layer; the profile of the line may comprise a shape; the profile of the feature may comprise a shape different than the profile of the line; the composite structure may comprise an airbag chute and an airbag module may comprise the airbag; the base layer may comprise a structural substrate for the cover; the cover may be formed by injection molding; the cover layer may be formed on the base layer; the base layer may comprise a base layer material; the cover layer may comprise a cover layer material; the base layer material may comprise an injection-molded material and the cover layer material may comprise an injection-molded material; the cover layer material may comprise a molded material formed on the base layer material; the base layer may comprise a color; the cover layer may comprise a color; the color of the base layer may be different than the color of the cover layer; the line may comprise a weakening line formed in the cover at the weakened area; the weakening line may be formed in the base layer and in the cover layer; the feature may comprise a pattern of recesses configured to form the line; the feature may comprise a set of groove sections coupling a set of features to provide the line as a weakening line at the weakened area of the cover; the line may be configured to be generally visually imperceptible at an exterior surface of the cover layer; the cover may be configured to provide a surface effect; the surface effect may comprise a visual effect at an exterior surface of the cover layer; the surface effect may comprise a tactile effect; the surface effect may comprise a protective effect; the surface effect may comprise a texture effect; the surface effect may comprise a color effect; the visual effect may comprise a decorative effect; the composite structure may comprise a surface layer on the cover layer; the surface layer may comprise a film and/or an applied coating; the component may comprise a steering wheel assembly and/or a trim component and/or a trim panel and or a trim panel for a steering wheel assembly.

The present invention relates to a component configured to facilitate formation of an opening for deployment of an airbag into an interior of a vehicle comprising a composite structure comprising cover comprising a base layer and a cover layer; the composite structure may comprise a line at a weakened area; the line may be configured to facilitate formation of the opening at the weakened area; the line may comprise a feature configured to facilitate formation of the opening; the feature may comprise a recess; the feature may comprise a set of features configured to form the line; the feature may comprise a set of features; the line may comprise the set of features; the set of features may comprise a pattern of features; the line may comprise a weakening line; the line may comprise a tear line; the line may comprise a seam; the line may comprise a groove; the line comprise a set of grooves; the line may comprise a section; the line may comprise a set of sections; the line may comprise a set of groove sections; the line may comprise a set of sections to couple each feature of a set of features; the composite structure may comprise a panel; the cover may comprise a panel; the component may comprise a steering wheel assembly; the composite structure may comprise a steering wheel assembly; the steering wheel assembly may comprise a frame; the steering wheel assembly may comprise an airbag module configured to provide the airbag; the steering wheel assembly may comprise a module configured to provide a user interface; the line may comprise a pattern; the pattern may comprise an H-shaped pattern; the pattern may comprise a U-shaped pattern; the line may comprise a seam; the seam may comprise a pattern; the seam may comprise an H-shape; the seam may comprise a U-shape; the seam may comprise a groove; the feature may comprise a groove; the feature may comprise a cavity; the feature may comprise a recess; the feature may comprise a profile; the feature may comprise a set of features; the set of features may comprise a set of recesses; the feature may comprise the set of recesses and a groove; the groove may be configured to couple a set of features; the seam may comprise a set of features; the seam may comprise groove comprising a set of features; the cover may comprise the line; the cover may comprise a groove; the cover may comprise the feature; the feature may be formed in the cover; the line may comprise a groove formed in the cover; the base layer of the cover may comprise the line; the line may be provided in the base layer of the cover; the line may be formed in the base layer of the cover; the line may comprise a set of features provided in the base layer of the cover; the line may comprise a set of features formed in the base layer of the cover; the line may comprise a set of features molded in the base layer of the cover; the line may comprise a set of features injected molded in the base layer of the cover; the line may comprise a set of features and a set of groove sections formed in the base layer of the cover; the feature may be formed in the base layer of the cover and the set of groove sections may be provided in the cover; the feature may be formed in the base layer of the cover and the cover layer of the cover; the feature may comprise a profile; each feature may comprise a profile; the profile may comprise a tapered profile; the profile may comprise a section; the profile may comprise an angled profile; the profile may comprise a sloped section; the profile may comprise a flat section; the profile may comprise a rounded section; the profile may comprise a contour; the profile may comprise a set of sections; the profile may comprise a ring-shaped section; the profile comprise a set of ring-shaped sections; the profile may comprise a set of sections and a tip; the profile may comprise a tip; the tip may comprise a closed section of the profile; the closed section of the profile may comprise a point; the profile may comprise a trapezoidal shape; the profile may comprise a V-shaped profile; the profile may comprise a U-shaped profile; the profile may comprise a symmetrical profile; the profile may comprise an asymmetrical profile; the profile may comprise an irregular-shaped profile; the profile may be formed into the cover; the profile may comprise a section formed into the cover; the profile may comprise an open section and a closed section formed into the cover; the profile may be formed into the base layer; the profile may comprise an open section; the profile may comprise an open section formed into the base layer of the cover; the profile may comprise a closed section formed into the base layer of the cover; the profile may be partially formed into the cover layer; the profile may comprise the closed section partially formed into the cover layer; the profile may comprise a residual section in the cover layer; the profile may comprise a residual depth in the cover layer; the line may comprise a profile; the line may comprise a notch; the line may comprise a symmetrical profile; the line may comprise an asymmetrical profile; each section of the line may comprise a profile; the profile of the line may comprise a groove-shaped profile; the profile of the line may comprise a U-shaped profile; the profile of the line may comprise a V-shaped profile; the profile of the line may be formed into the cover; the profile of the line may be formed into the base layer; the profile of the line may be partially formed into the cover layer; the profile of the line may comprise a shape; the profile of the feature may comprise a shape different than the profile of the line; the profile of the line may comprise a depth; the profile of the feature may comprise a depth larger than the profile of the line; the profile of the line may comprise a width; the profile of the feature may comprise a width larger than the profile of the line.

The present invention relates to a component configured to facilitate formation of an opening for deployment of an airbag into an interior of a vehicle comprising a composite structure comprising cover comprising a base layer and a cover layer; the composite structure may comprise a substrate; the composite structure may comprise a carrier; the composite structure may comprise a housing; the composite structure may comprise a chute; the housing may comprise a chute; the chute may comprise an airbag chute; the composite structure may comprise a steering wheel assembly comprising an airbag chute; the composite structure may comprise an airbag chute and an airbag module comprising the airbag; the cover may comprise a cover plate; the cover plate may comprise a panel; the composite structure may comprise a panel; the composite structure may comprise a structural substrate; the base layer may comprise a substrate; the base layer may comprise a structural substrate; the base layer may comprise a panel; the cover layer may comprise an exterior surface; the cover layer may comprise a skin layer; the base layer may comprise a structural layer; the base layer may comprise a structural substrate for the cover; the composite structure may comprise a molded structure; the cover may comprise a molded structure; the cover may comprise a molded layer; the cover may comprise a molded cover; the cover may be formed by injection molding; the cover layer may be formed on the base layer; the base layer may comprise a base layer material; the cover layer may comprise a cover layer material; the base layer material may be different than the cover layer material; the base layer material may comprise a polymer material; the cover layer material may comprise a polymer material; the base layer material may comprise an injection-molded material and the cover layer material may comprise an injection-molded material; the cover layer material may comprise a molded material formed on the base layer material; the base layer may comprise a color; the cover layer may comprise a color; the color of the base layer may be different than the color of the cover layer; the cover may comprise a two-color cover; the cover may comprise a multi-color cover; the line may comprise a weakening line formed in the cover at the weakened area; the weakening line may be formed in the base layer; the weakening line may be formed in the base layer and in the cover layer; the feature may comprise a pattern of recesses; the feature may comprise a pattern of recesses configured to form the line; the feature may comprise an aperture; the feature may comprise a set of apertures; the feature may comprise a hole; the feature may comprise a set of holes; the feature may comprise a pattern of features configured to provide the line as a weakening line at the weakened area of the cover; the feature may comprise a set of groove sections coupling a pattern of features to provide the line as a weakening line at the weakened area of the cover; the feature may comprise a set of groove sections coupling a set of features to provide the line as a weakening line at the weakened area of the cover; the line may be configured to be generally visually imperceptible at an exterior surface of the cover layer; the line may be configured to be generally tactically imperceptible at the cover layer; the line may be configured to be generally tactically imperceptible at an exterior surface of the cover layer; the line may be configured to be generally tactically imperceptible at the cover layer; the cover may be configured to provide a surface effect; the surface effect may comprise a visual effect at an exterior surface of the cover layer; the surface effect may comprise a tactile effect; the surface effect may comprise a protective effect; the surface effect may comprise a texture effect; the surface effect may comprise a color effect; the visual effect may comprise a decorative effect; the decorative effect may comprise a color effect; the decorative effect may comprise a grain effect; the decorative effect may comprise a leather effect; the composite structure may comprise a surface layer on the cover layer; the surface layer may comprise a coating on the cover layer; the coating may be configured to provide a surface effect for the cover; the surface layer may comprise a film and/or an applied coating; the composite structure comprise a contoured shape; the component may comprise a steering wheel assembly and/or a trim component and/or a trim panel and or a trim panel for a steering wheel assembly; the component may comprise a steering wheel assembly comprising an airbag module comprising the airbag.

The present invention relates to a component configured to facilitate formation of an opening for deployment of an airbag into an interior of a vehicle comprising a composite structure comprising cover comprising a base layer and a cover layer; the composite structure may comprise a line at a weakened area; the line may be configured to facilitate formation of the opening at the weakened area; the line may comprise a profile configured to facilitate formation of the opening; the line may comprise a molded line in the cover; the line may comprise a pattern configured to facilitate formation of the opening; the profile may comprise an open section formed in the base layer of the cover; the profile may comprise a closed section formed in the cover; the closed section of the profile may be formed in the cover layer of the cover; the line may comprise a set of features; the line may comprise a pattern of features; the line may comprise a set of groove sections; the set of groove features may be coupled to the set of features; each feature of the set of features may comprise a feature profile; each groove of the set of groove sections may comprise a groove profile; the cover of the composite structure may be formed by double-color injection molding of the cover layer onto the base layer; the cover may comprise an intermediate layer; the cover may comprise an interface layer; the cover may comprise a coating; the line may comprise a closed section and a depth and a residual thickness; each feature may comprise a closed section and a depth and a residual thickness; each feature may comprise a recess comprising a closed section and a depth and a residual thickness; each recess comprising a wall section; each groove section may comprise a closed section and a depth and a residual thickness; the line may comprise a seam groove in the cover configured to provide a tear path and/or a break line at the weakened area; the line may comprise a thinned region comprising a thickness reduction zone in the cover; the line may be configured to direct formation of the opening; the line may comprise a lower strength region and/or a rupture initiation region and/or a fracture initiation region and/or a deployment path and/or a force concentration region and/or a tear propagation section and/or a localized weakening section and/or a stress concentration region; the cover may comprise a resin material; the cover may comprise a resin structure; the cover may comprise a resin and/or a synthetic leather and/or a foam material and/or a molded resin and/or an injection molded material; the cover layer may comprise an overmolded material and/or a molded skin; the composite structure may comprise a molded substrate and/or a molded panel; the surface effect of the cover may comprise a stitched cover effect and/or a stitched seam effect and/or a decorative layer effect and/or a surface finish; the cover of the composite structure may comprise a cover plate for a steering wheel assembly; the cover layer may comprise a skin layer on an outer surface of the base layer; the base layer may comprise a skeleton layer; the line may comprise a weakening line configured on the cover plate; the weakening line comprising a tear-off section; the weakening line comprising an extension section connected to the tear-off section; the strength of the tear-off section may be less than strength of the extension section; the line may comprise a closed section and a residual thickness between the closed section and an exterior surface of the cover layer; the line may comprise a recessed feature configured to facilitate formation of the opening; the line may comprise a groove-connected set of features; the line may comprise a thickness reduction zone configured to provide a weakened section along the line; the line may comprise a deployment seam and/or a molded seam formed and/or symmetrical groove profile and/or an asymmetrical groove profile and/or a V-shaped pattern and/or an H-shaped pattern and/or a localized weakened region and/or a line of weakness and/or a molded line configured to rupture and/or a residual section configured to control tear propagation and/or a groove segment having a residual thickness less than an adjacent region and/or a recessed groove network; the composite structure may comprise a molded structure and/or a resin structure and/or a layered structure; the weakened area of cover may comprise the line configured to provide a weakened line and/or a weakened structure and/or a recessed structure and/or a groove structure and/or a seam structure and/or an interface structure for the weakened area and/or a residual structure in the weakened area and/or a transition structure; the cover may comprise a contour shape; the profile of the feature may comprise a contour; the feature may comprise a thickness transition zone and/or a localized weakening structure and/or fracture initiation geometry and or a reduced-thickness section and/or feature and/or a residual material bridge and/or a groove-connected recess and/or a multi-section profile and/or a molded tear geometry and/or a contour-controlled rupture path;

the component may comprise a steering wheel assembly comprising an airbag module comprising an airbag.

### FIGURES

FIG. 1A is schematic perspective view of a vehicle according to an exemplary embodiment.

FIG. 1B is a schematic perspective view of a vehicle interior according to an exemplary embodiment.

FIG. 2 is a schematic perspective view of a vehicle interior according to an exemplary embodiment.

FIG. 3 is a schematic side elevation view of a vehicle interior according to an exemplary embodiment.

FIG. 4 is a schematic perspective view of a composite structure for a component for a vehicle interior according to an exemplary embodiment.

FIG. 5A is a schematic perspective view of operation of a composite structure for a component for a vehicle interior according to an exemplary embodiment.

FIG. 5B is a schematic perspective view of operation of a composite structure for a component for a vehicle interior according to an exemplary embodiment.

FIG. 5C is a schematic perspective view of operation of a composite structure for a component for a vehicle interior according to an exemplary embodiment.

FIG. 6A is a schematic perspective view of operation of a composite structure for a component for a vehicle interior according to an exemplary embodiment.

FIG. 6B is a schematic perspective view of operation of a composite structure for a component for a vehicle interior according to an exemplary embodiment.

FIG. 6C is a schematic perspective view of operation of a composite structure for a component for a vehicle interior according to an exemplary embodiment.

FIG. 7 is a schematic perspective view of a composite structure for a component for a vehicle interior according to an exemplary embodiment.

FIG. 8A is a schematic perspective view of a composite structure for a component for a vehicle interior according to an exemplary embodiment.

FIG. 8B is a schematic perspective view of a composite structure for a component for a vehicle interior according to an exemplary embodiment.

FIG. 9A is a schematic side elevation view of operation of a composite structure for a component for a vehicle interior according to an exemplary embodiment.

FIG. 9B is a schematic side elevation view of operation of a composite structure for a component for a vehicle interior according to an exemplary embodiment.

FIG. 9C is a schematic side elevation view of operation of a composite structure for a component for a vehicle interior according to an exemplary embodiment.

FIG. 9D is a schematic side elevation view of operation of a composite structure for a component for a vehicle interior according to an exemplary embodiment.

FIG. 9E is a schematic side elevation view of operation of a composite structure for a component for a vehicle interior according to an exemplary embodiment.

FIG. 9F is a schematic side elevation view of operation of a composite structure for a component for a vehicle interior according to an exemplary embodiment.

FIG. 9G is a schematic side elevation view of operation of a composite structure for a component for a vehicle interior according to an exemplary embodiment.

FIG. 10A is a schematic side elevation view of operation of a composite structure for a component for a vehicle interior according to an exemplary embodiment.

FIG. 10B is a schematic side elevation view of operation of a composite structure for a component for a vehicle interior according to an exemplary embodiment.

FIG. 10C is a schematic side elevation view of operation of a composite structure for a component for a vehicle interior according to an exemplary embodiment.

FIG. 11A is a schematic top plan view of operation of a composite structure for a component for a vehicle interior according to an exemplary embodiment.

FIG. 11B is a schematic top plan view of operation of a composite structure for a component for a vehicle interior according to an exemplary embodiment.

FIG. 11C is a schematic top plan view of operation of a composite structure for a component for a vehicle interior according to an exemplary embodiment.

FIG. 12A is a schematic perspective view of a composite structure for a component for a vehicle interior according to an exemplary embodiment.

FIG. 12B is a schematic perspective view of a composite structure for a component for a vehicle interior according to an exemplary embodiment.

FIG. 13A is a schematic perspective view of a composite structure for a component for a vehicle interior according to an exemplary embodiment.

FIG. 13B is a schematic perspective view of a composite structure for a component for a vehicle interior according to an exemplary embodiment.

FIG. 14 is a schematic perspective view of a composite structure for a component for a vehicle interior according to an exemplary embodiment.

FIG. 15A is a schematic perspective view of operation of a composite structure for a component for a vehicle interior according to an exemplary embodiment.

FIG. 15B is a schematic perspective view of operation of a composite structure for a component for a vehicle interior according to an exemplary embodiment.

FIG. 15C is a schematic perspective view of operation of a composite structure for a component for a vehicle interior according to an exemplary embodiment.

FIG. 16 is a schematic perspective view of a composite structure for a component for a vehicle interior according to an exemplary embodiment.

FIG. 17A is a schematic perspective view of operation of a composite structure for a component for a vehicle interior according to an exemplary embodiment.

FIG. 17B is a schematic perspective view of operation of a composite structure for a component for a vehicle interior according to an exemplary embodiment.

FIG. 17C is a schematic perspective view of operation of a composite structure for a component for a vehicle interior according to an exemplary embodiment.

FIG. 18A is a schematic perspective view of operation of a composite structure for a component for a vehicle interior according to an exemplary embodiment.

FIG. 18B is a schematic perspective view of operation of a composite structure for a component for a vehicle interior according to an exemplary embodiment.

FIG. 18C is a schematic perspective view of operation of a composite structure for a component for a vehicle interior according to an exemplary embodiment.

FIG. 18D is a schematic perspective view of operation of a composite structure for a component for a vehicle interior according to an exemplary embodiment.

FIG. 18E is a schematic perspective view of operation of a composite structure for a component for a vehicle interior according to an exemplary embodiment.

FIG. 18F is a schematic perspective view of operation of a composite structure for a component for a vehicle interior according to an exemplary embodiment.

FIG. 19A is a schematic perspective view of operation of a composite structure for a component for a vehicle interior according to an exemplary embodiment.

FIG. 19B is a schematic perspective view of operation of a composite structure for a component for a vehicle interior according to an exemplary embodiment.

FIG. 19C is a schematic perspective view of operation of a composite structure for a component for a vehicle interior according to an exemplary embodiment.

FIG. 19D is a schematic perspective view of operation of a composite structure for a component for a vehicle interior according to an exemplary embodiment.

FIG. 19E is a schematic perspective view of operation of a composite structure for a component for a vehicle interior according to an exemplary embodiment.

FIG. 19F is a schematic perspective view of operation of a composite structure for a component for a vehicle interior according to an exemplary embodiment.

FIG. 20A is a schematic perspective view of operation of a composite structure for a component for a vehicle interior according to an exemplary embodiment.

FIG. 20B is a schematic perspective view of operation of a composite structure for a component for a vehicle interior according to an exemplary embodiment.

FIG. 20C is a schematic perspective view of operation of a composite structure for a component for a vehicle interior according to an exemplary embodiment.

FIG. 20D is a schematic perspective view of operation of a composite structure for a component for a vehicle interior according to an exemplary embodiment.

FIG. 20E is a schematic perspective view of operation of a composite structure for a component for a vehicle interior according to an exemplary embodiment.

FIG. 20F is a schematic perspective view of operation of a composite structure for a component for a vehicle interior according to an exemplary embodiment.

FIG. 20G is a schematic perspective view of operation of a composite structure for a component for a vehicle interior according to an exemplary embodiment.

FIG. 20H is a schematic perspective view of operation of a composite structure for a component for a vehicle interior according to an exemplary embodiment.

FIG. 21A is a schematic top plan view of operation of a composite structure for a component for a vehicle interior according to an exemplary embodiment.

FIG. 21B is a schematic top plan view of operation of a composite structure for a component for a vehicle interior according to an exemplary embodiment.

FIG. 21C is a schematic top plan view of operation of a composite structure for a component for a vehicle interior according to an exemplary embodiment.

FIG. 21D is a schematic top plan view of operation of a composite structure for a component for a vehicle interior according to an exemplary embodiment.

FIG. 21E is a schematic top plan view of operation of a composite structure for a component for a vehicle interior according to an exemplary embodiment.

FIG. 21F is a schematic top plan view of operation of a composite structure for a component for a vehicle interior according to an exemplary embodiment.

FIG. 21G is a schematic top plan view of operation of a composite structure for a component for a vehicle interior according to an exemplary embodiment.

FIG. 21H is a schematic top plan view of operation of a composite structure for a component for a vehicle interior according to an exemplary embodiment.

FIG. 22A is a schematic perspective view of a composite structure for a component for a vehicle interior according to an exemplary embodiment.

FIG. 22B is a schematic perspective view of a composite structure for a component for a vehicle interior according to an exemplary embodiment.

FIGS. 22C through 22E are schematic detail side elevation views of a composite structure for a component for a vehicle interior according to an exemplary embodiment.

FIG. 23A is a schematic perspective view of a composite structure for a component for a vehicle interior according to an exemplary embodiment.

FIG. 23B is a schematic perspective view of a composite structure for a component for a vehicle interior according to an exemplary embodiment.

FIG. 23C is a schematic detail side elevation view of a composite structure for a component for a vehicle interior according to an exemplary embodiment.

FIG. 24 is a schematic perspective view of a composite structure for a component for a vehicle interior according to an exemplary embodiment.

FIG. 24A is a schematic perspective view of a set of a features of a composite structure for a component for a vehicle interior according to an exemplary embodiment.

FIG. 25 is a schematic perspective view of a composite structure for a component for a vehicle interior according to an exemplary embodiment.

FIGS. 25A through 25C are schematic detail side elevation views of a composite structure for a component for a vehicle interior according to an exemplary embodiment.

FIG. 26 is a schematic perspective view of a composite structure for a component for a vehicle interior according to an exemplary embodiment.

FIG. 26A is a schematic perspective view of a set of features of a composite structure for a component for a vehicle interior according to an exemplary embodiment.

FIG. 27 is a schematic perspective view of a composite structure for a component for a vehicle interior according to an exemplary embodiment.

FIGS. 28A and 28B are schematic perspective view of a composite structure for a component for a vehicle interior according to an exemplary embodiment.

FIGS. 29A and 29B are schematic detail view of a composite structure for a component for a vehicle interior according to an exemplary embodiment.

FIG. 30 is a schematic perspective detail view of a composite structure for a component for a vehicle interior according to an exemplary embodiment.

FIG. 31 is a schematic side elevation view of a composite structure for a component for a vehicle interior according to an exemplary embodiment.

FIG. 31A is a schematic perspective detail view of a composite structure for a component for a vehicle interior according to an exemplary embodiment.

FIG. 32 is a schematic side elevation view of a composite structure for a component for a vehicle interior according to an exemplary embodiment.

FIG. 32A is a schematic perspective detail view of a composite structure for a component for a vehicle interior according to an exemplary embodiment.

FIG. 33A is a schematic perspective view of a composite structure for a component for a vehicle interior according to an exemplary embodiment.

FIG. 33B is a schematic perspective view of a composite structure for a component for a vehicle interior according to an exemplary embodiment.

FIG. 34A is a schematic side elevation view of a composite structure for a component for a vehicle interior according to an exemplary embodiment.

FIG. 34B is a schematic perspective view of a composite structure for a component for a vehicle interior according to an exemplary embodiment.

FIG. 35A is a schematic side elevation view of a composite structure for a component for a vehicle interior according to an exemplary embodiment.

FIG. 35B is a schematic perspective detail view of a composite structure for a component for a vehicle interior according to an exemplary embodiment.

FIG. 35C is a schematic perspective detail view of a composite structure for a component for a vehicle interior according to an exemplary embodiment.

FIG. 36A is a schematic perspective view of a composite structure for a component for a vehicle interior according to an exemplary embodiment.

FIG. 36B is a schematic perspective view of a composite structure for a component for a vehicle interior according to an exemplary embodiment.

FIG. 36C is a schematic perspective view of a composite structure for a component for a vehicle interior according to an exemplary embodiment.

FIG. 36D is a schematic perspective view of a composite structure for a component for a vehicle interior according to an exemplary embodiment.

FIG. 37A is a schematic perspective view of a composite structure for a component for a vehicle interior according to an exemplary embodiment.

FIG. 37B is a schematic perspective view of a composite structure for a component for a vehicle interior according to an exemplary embodiment.

FIG. 38 is a schematic perspective view of a composite structure for a component for a vehicle interior according to an exemplary embodiment.

FIG. 39 is a schematic perspective view of a composite structure for a component for a vehicle interior according to an exemplary embodiment.

FIG. 39A is a schematic perspective view of a composite structure for a component for a vehicle interior according to an exemplary embodiment.

FIG. 39B is a schematic perspective view of a composite structure for a component for a vehicle interior according to an exemplary embodiment.

FIG. 40 is a schematic perspective view of a composite structure for a component for a vehicle interior according to an exemplary embodiment.

FIG. 41 is a schematic perspective view of a composite structure for a component for a vehicle interior according to an exemplary embodiment.

FIG. 42 is a schematic perspective view of a composite structure for a component for a vehicle interior according to an exemplary embodiment.

FIG. 43 is a schematic perspective view of a composite structure for a component for a vehicle interior according to an exemplary embodiment.

FIG. 44 is a schematic side elevation view of a composite structure for a component for a vehicle interior according to an exemplary embodiment.

FIG. 45 is a schematic side elevation view of a composite structure for a component for a vehicle interior according to an exemplary embodiment.

FIG. 45A is a schematic perspective view of a composite structure for a component for a vehicle interior according to an exemplary embodiment.

FIG. 45B is a schematic perspective view of a composite structure for a component for a vehicle interior according to an exemplary embodiment.

FIG. 46 is a schematic side elevation view of a composite structure for a component for a vehicle interior according to an exemplary embodiment.

FIG. 46A is a schematic perspective view of a composite structure for a component for a vehicle interior according to an exemplary embodiment.

FIG. 47 is a schematic perspective view of a composite structure for a component for a vehicle interior according to an exemplary embodiment.

FIG. 48 is a schematic side elevation view of a composite structure for a component for a vehicle interior according to an exemplary embodiment.

FIG. 48A is a schematic perspective view of a composite structure for a component for a vehicle interior according to an exemplary embodiment.

FIG. 49 is a schematic side elevation view of a composite structure for a component for a vehicle interior according to an exemplary embodiment.

FIG. 50 is a schematic perspective view of a composite structure for a component for a vehicle interior according to an exemplary embodiment.

FIG. 51 is a schematic side elevation view of a composite structure for a component for a vehicle interior according to an exemplary embodiment.

FIG. 52 is a schematic side elevation view of a composite structure for a component for a vehicle interior according to an exemplary embodiment.

FIG. 53 is a schematic side elevation view of a composite structure for a component for a vehicle interior according to an exemplary embodiment.

FIG. 54 is a schematic side elevation view of a composite structure for a component for a vehicle interior according to an exemplary embodiment.

FIG. 55 is a schematic perspective view of a composite structure for a component for a vehicle interior according to an exemplary embodiment.

### DESCRIPTION

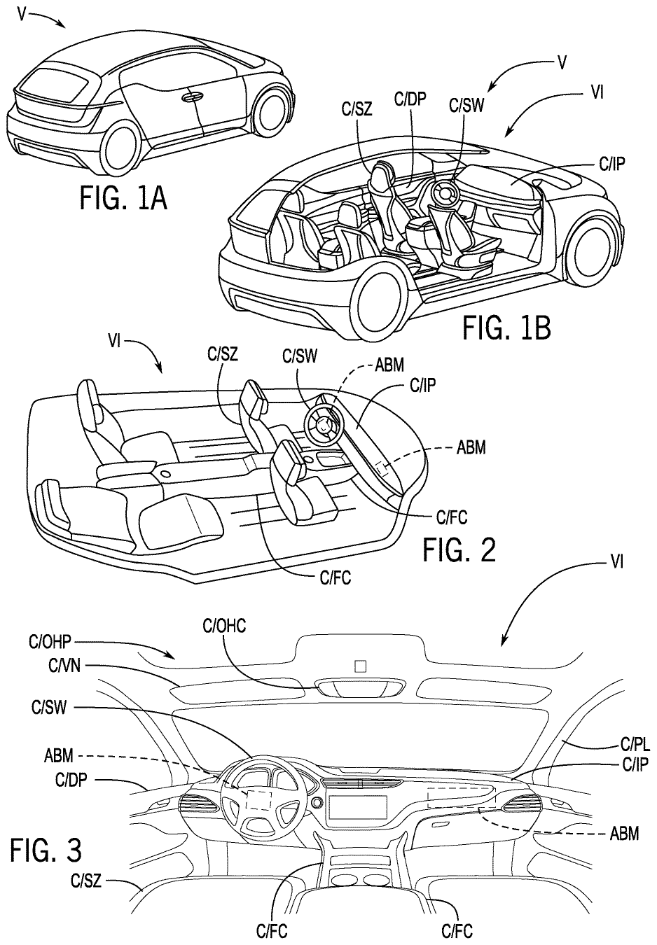

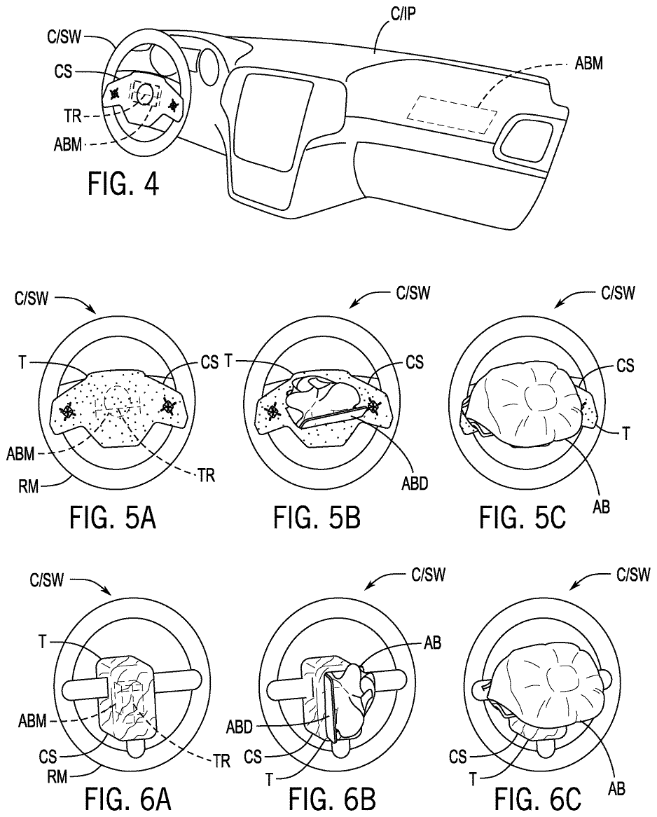

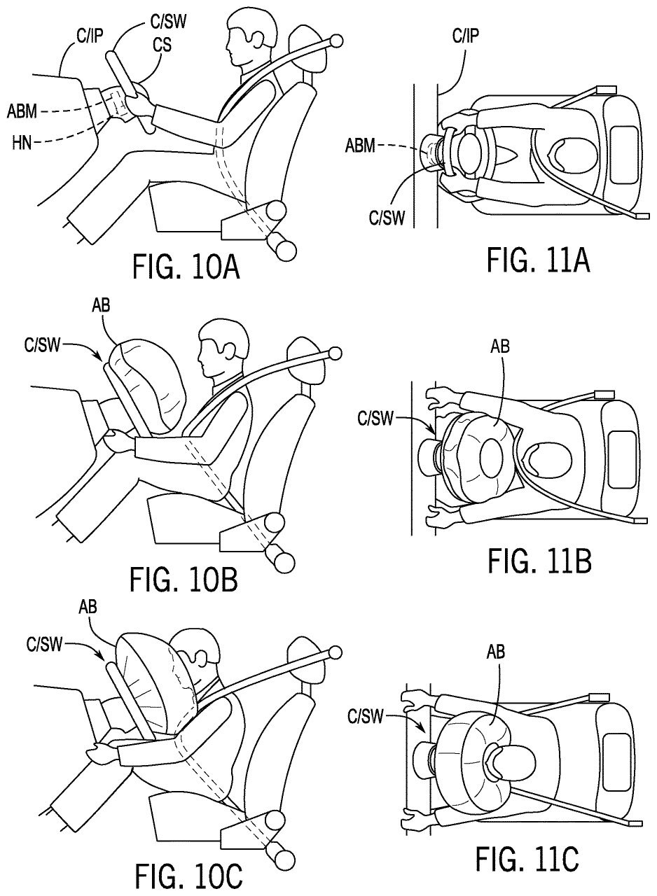

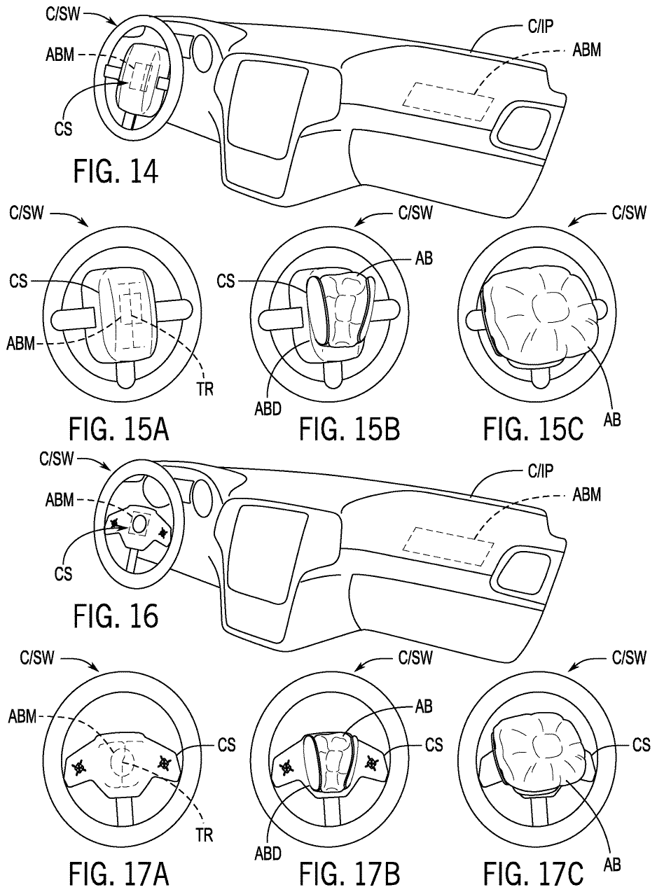

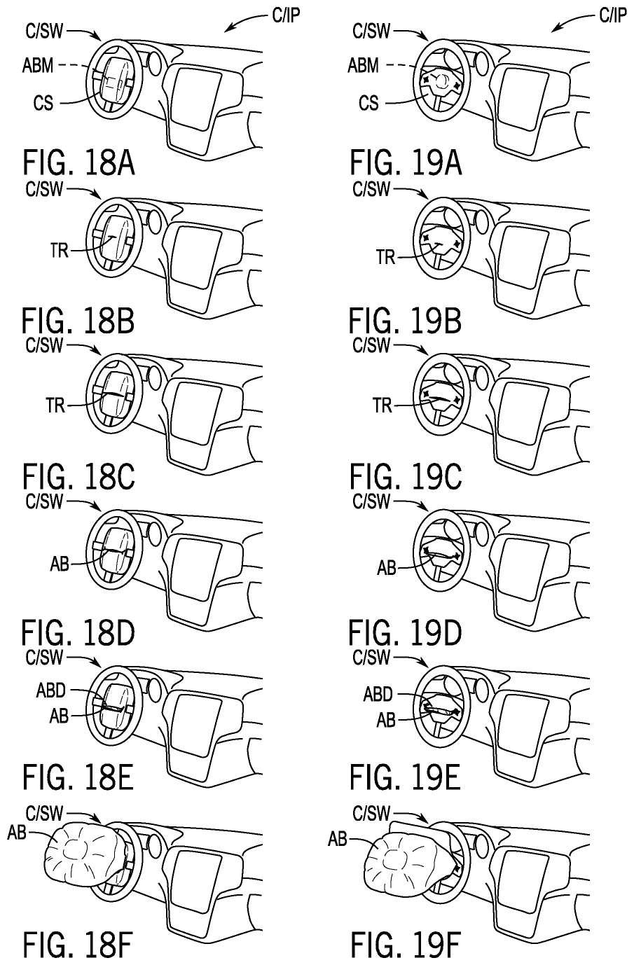

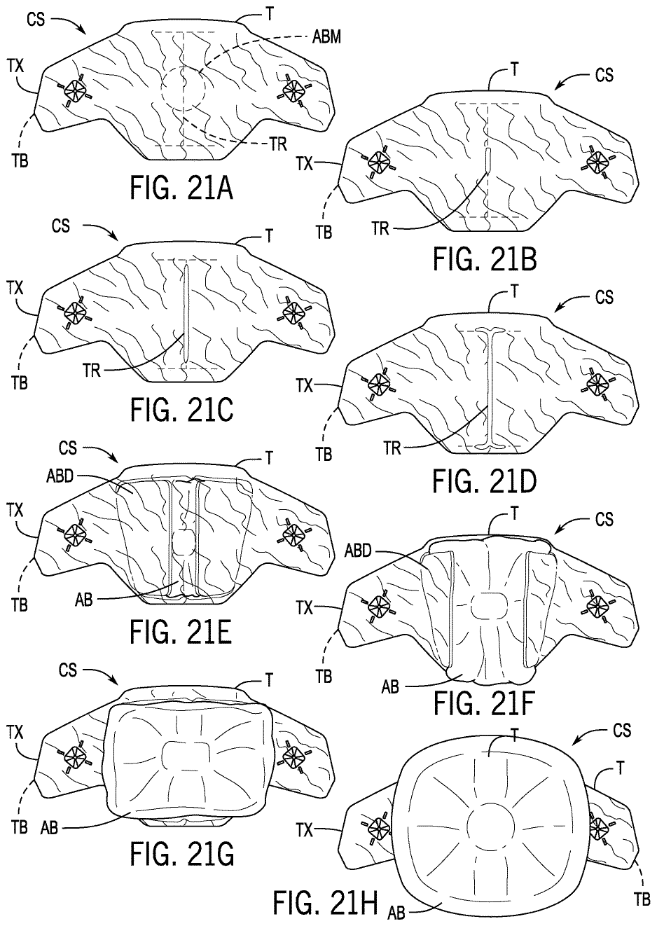

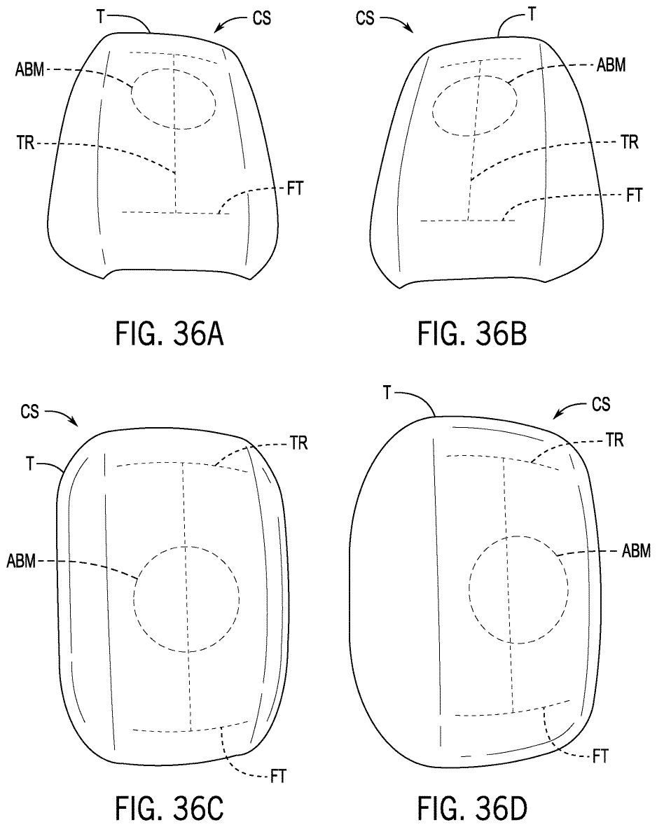

Referring to FIGS. 1A and 1B, a vehicle V may comprise a vehicle interior VI with components C such as a steering wheel/assembly SW, an instrument panel IP, a door panel DP, a seat assembly SZ, a console such as floor console FC, an overhead panel OHP, an overhead console/system OHC, a visor/vanity VN, a pillar PL, and/or another trim, panels, components, etc. configured for the vehicle interior VI. As indicated schematically according to an exemplary embodiment in FIGS. 2, 3, 4, 5A-5C, 6A-6C, 7, 8A-8B, 14, 16, 36A-36D and 37A-37B, the component C may comprise a composite structure CS comprising a cover T with a base layer TB and a cover layer TX; the component C may comprise an airbag module ABM configured to deploy an airbag AB from the composite structure CS into the interior of the vehicle; the composite structure CS with cover T may be configured to provide a line/seam shown as a tear line TR facilitate formation of the opening for deployment of the airbag AB into the vehicle interior VI. See also FIGS. 9A-9G, 10A-10C and 11A-11C. As indicated schematically in FIGS. 2, 3, 4, 5A-5C, 6A-6C, 9A-9H, 10A-10C, 11A-11C, 12A-12B and 13A-13B, component C shown as steering wheel/assembly SW with rim RM and user interface module HN and airbag module ABM with airbag AB may comprise the composite structure CS comprising cover T configured to deploy the airbag AB through an opening formed as an airbag door ABD at the line/seam TR in cover T. See also FIGS. 14, 15A-15C, 16, 17A-17C, 18A-18F, 19A-19F, 20A-20H and 21A-21H.

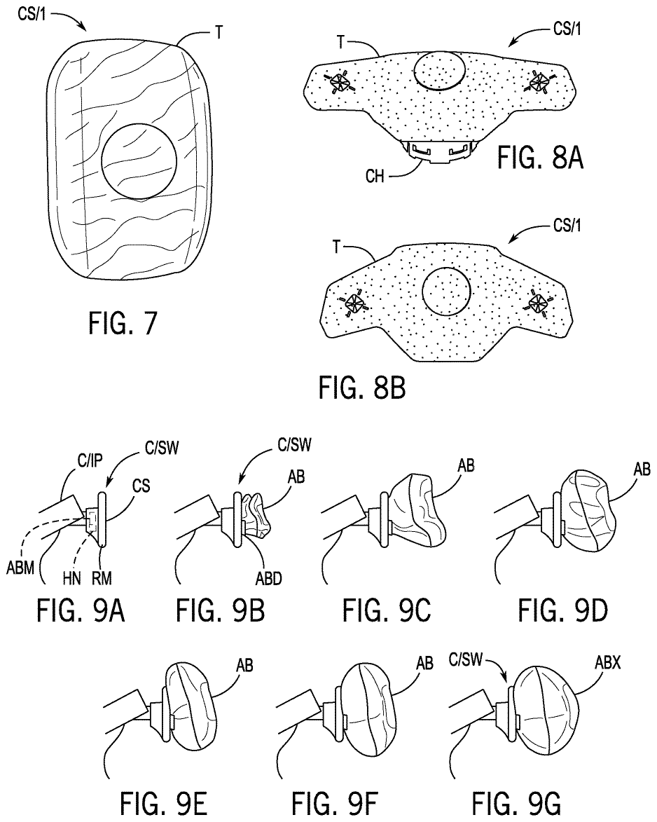

As indicated schematically according to an exemplary embodiment in FIGS. 7, 8A-8B, 12A-12B, 13A-13B, 20A-20H, 21A-21H, 22A-22E, 23A-23C, 24, 24A, 25, 25A-25C, 26 and 26A, composite structure CS may comprise cover T for assembly into the component C (such as on a base, carrier, etc.); cover T may comprise a multi-layer/multi-section configuration comprising base layer TB with substrate SB and cover layer TX; base layer TB may comprise a substrate SB (such as a structural substrate, form layer, etc.); cover layer TX may comprise a surface layer TC (such as coating, film, etc.); as indicated schematically, a line such as a seam/tear weakening line TR in a weakened area of cover T of composite structure CS comprising a set of sections (such as grooves, etc.) and/or a set/pattern of features FT (such as recesses, indentations, etc.) may be provided/formed in the cover T of composite structure CS to facilitate/direct formation at the seam/tear line for deployment of the airbag AB through cover T. See also FIGS. 5A-5C, 6A-6C, 9A-9H, 10A-10C, 11A-11C, 15A-15C, 17A-17C, 18A-18F and 19A-19F.

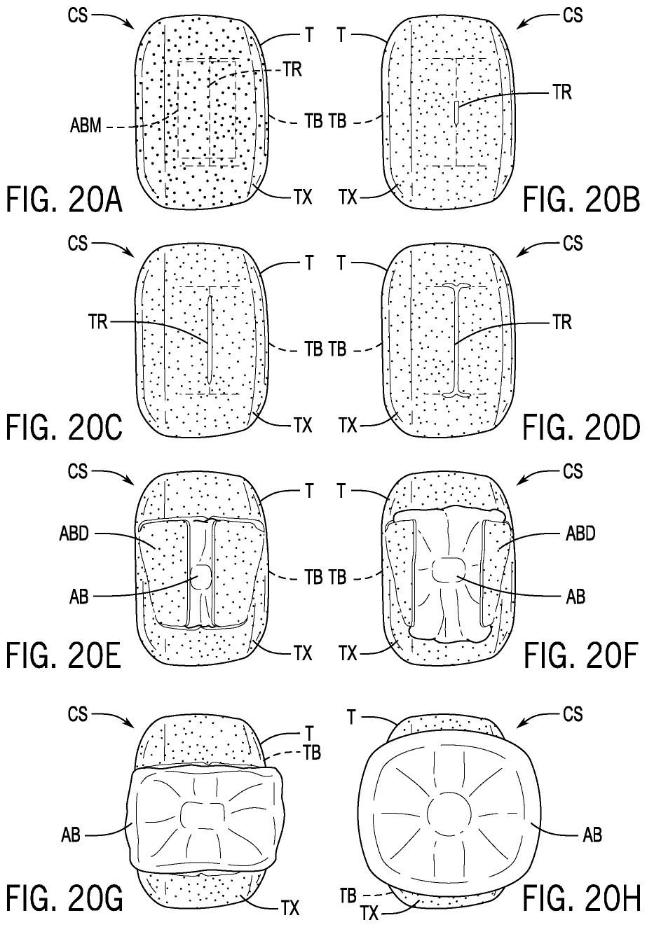

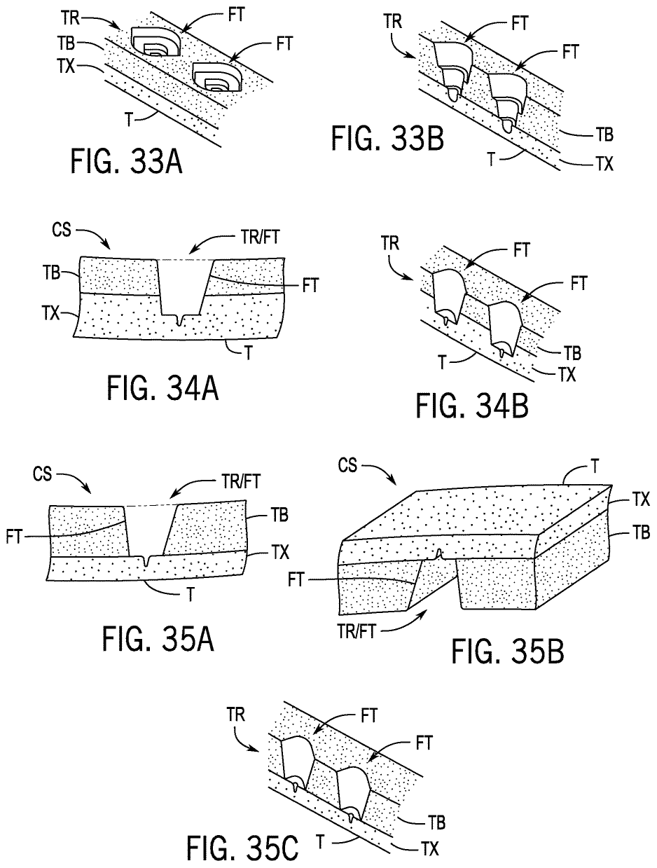

As indicated schematically according to an exemplary embodiment in FIGS. 20A-20H, 21A-21H, 22A-22E, 23A-23C, 24, 24A, 25, 25A-25C, 26, 26A, 27, 28A-28B, 29A-29B, 30, 31, 31A, 32, 32A, 33A-33B, 34A-34B and 35A-35C, the line TR shown as seam/tear weakening line TR in a weakened area of cover T of composite structure CS may be provided in a variety of configurations in base layer TB and/or cover layer TX of cover T; the line TR may comprise a set of grooves TR comprising a profile/depth; the line TR may comprise a set/pattern of features shown as recesses FT comprising a profile/depth formed in the cover T.

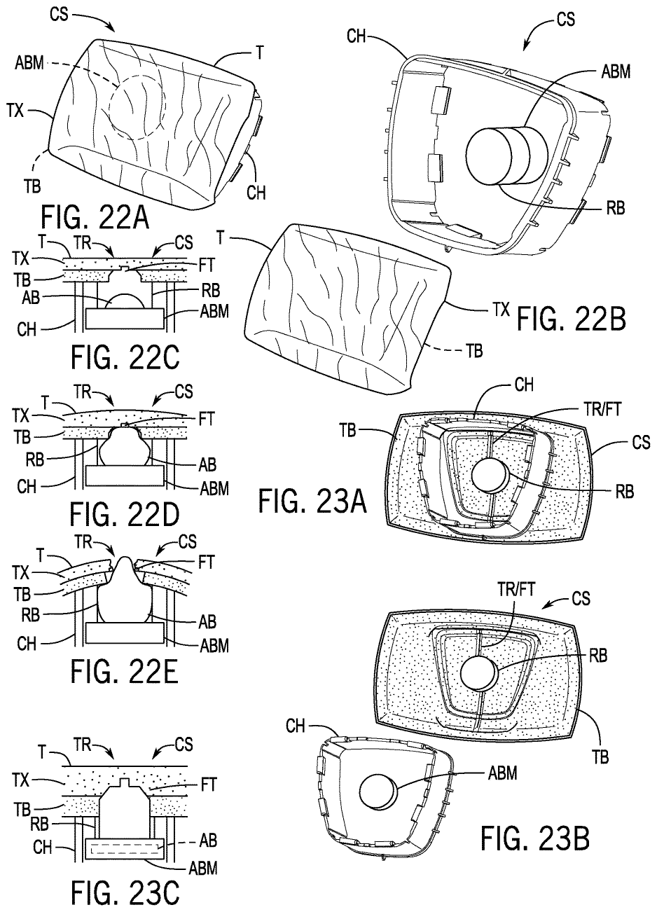

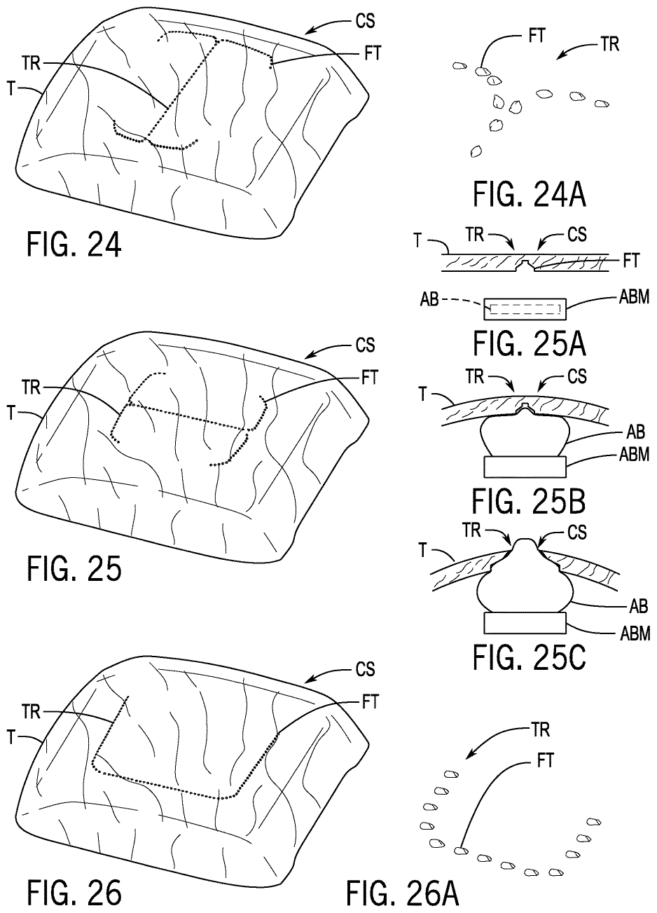

According to an exemplary embodiment as shown schematically in FIGS. 24, 24A, 25, 26, 26A, 27, 28A-28B, 29A-29B, 30, 31, 31A, 32, 32A, 33A-33B, 34A-34B and 35A-35C, the seam/line TR is cover T of composite structure CS may be formed by a pattern/set of features shown as recesses FT; each recess FT may comprise a formed recess in base layer TB and/or cover layer TX of cover T; each feature FT may comprise a cavity, aperture, hole, groove, profile, or other formed structure; each feature FT may comprise a profile; each profile may comprise an open section and/or a closed section; the profile may comprise a tapered profile, sloped section, angled section, flat section, rounded section, tip, point, trapezoidal profile, V-shaped profile, U-shaped profile, multi-section profile, uniform-section profile, symmetrical profile, asymmetrical profile, irregular profile, or other profile; the features FT may be provided/formed in a pattern to provide weakening line TR; the features FT may be provided in a groove/notch provided/formed to provide weakening line TR; the weakening line TR in cover T of composite structure may be provided in a form to direct formation of the opening for deployment of the airbag AB from the airbag module through the cover T. See FIGS. 22A-22E, 23A-23C, 24, 24A, 25, 25A-25C, 26, 26A, 27, 28A-28B, 29A-29B, 30, 31, 31A, 32, 32A, 33A-33B, 34A-34B and 35A-35C.

As indicated schematically in FIGS. 22A-22E, 23A-23C 25 and 25A-25C, the cover T may comprise the line TR at the weakened area of composite structure CS; line TR may comprise the set of features FT arranged in a selected pattern with a profile in the cover T and/or connected by sections/segments shown as groove sections GR with a profile in the cover T; the selected configuration of weakening line TR will direct/facilitate formation of the opening for airbag AB to be deployed through the cover T of the composite structure at the weakened area.

See also FIGS. 29A-29B, 30, 31, 31A, 32, 32A, 33A-33B, 34A-34B and 35A-35C. As indicated schematically in FIGS. 24A, 25, 25A-25C, 26 and 26A, line TR may comprise features/recesses FT; the profile of feature/recess FT may comprise an open section and a closed section; the profile may be formed into the cover T; the profile may be formed into the base layer TB; the profile may be at least partially formed into the cover layer TX. See also FIGS. 31, 31A, 32, 32A, 33A-33B, 34A-34B, 35A-35C, 40, 45, 45A-45B, 46, 48 and 48A.

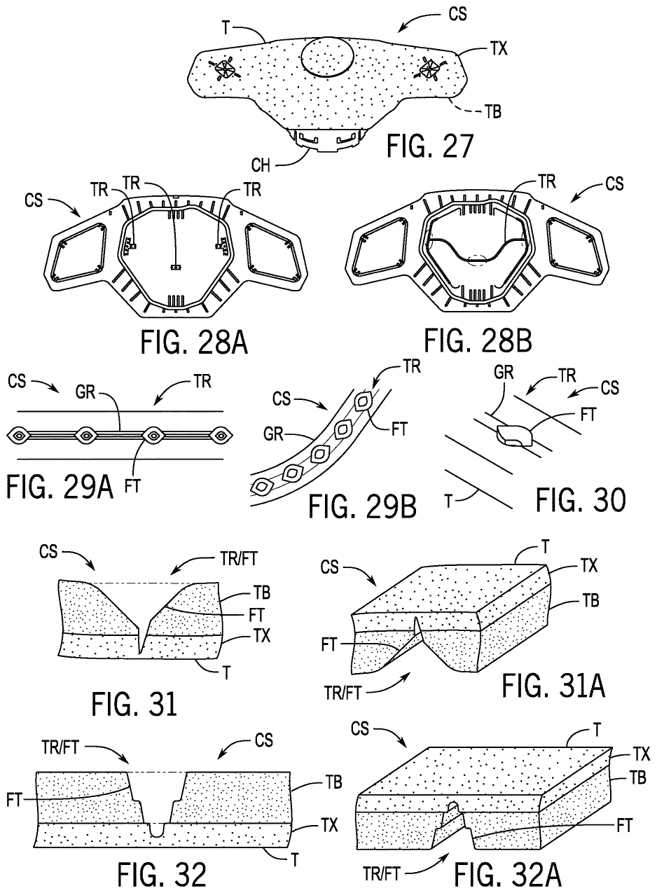

As indicated schematically in FIGS. 27, 28A-28B, 29A-29B, and 30, line TR may comprise groove sections GR and/or of features FT (shown as recesses connected by groove sections); the profile of groove sections GR and/or feature/recess FT may comprise an open section and a closed section; the profile may be formed into the cover T; the profile may be formed into the base layer TB; the profile may be at least partially formed into the cover layer TX. See also FIGS. 31, 31A, 32, 32A, 33A-33B, 34A-34B, 35A-35C, 40, 45, 45A-45B, 46, 48 and 48A. As indicated schematically, the composite structure CS may comprise the cover T with weakening/seam shown as tear line TR arranged at the weakened area of the cover T in a pattern configured to facilitate formation of the opening through the cover T. See also FIGS. 20A-20H, 21A-21H, 29A-29B and 36A-36D. As indicated schematically, the groove sections GR and/or set of features/recesses FT may be formed at least partially in the base layer TB and/or at least partially in the cover layer TX.

As indicated schematically in the FIGURES, the composite structure CS may comprise a cover T in a variety of configurations and/or with seam/tear line TR in a variety of configurations. The tear line TR may comprise a line, seam, seam line, weakening line, groove, set of groove sections GR, set of sections, set of segments, set of features, etc.; tear line TR may be arranged in an I-shaped pattern, T-shaped pattern, H-shaped pattern, U-shaped pattern, V-shaped pattern, curved pattern, segmented pattern, or other pattern configured to facilitate formation of the opening. See also FIGS. 20A-20H, 21A-21H, 24, 25, 26, 26A, 28A-28B, 29A-29B, 36A-36D, 37A-37B, 38, 39, 39A-39B, 43, 44, 47, 50 and 55.

As indicated schematically in FIGS. 22A-22E and 23A-23C, the composite structure CS may comprise the cover T and a structure such reinforcement structure RB (e.g. formed structure, molded structure, resin structure, etc.) configured to support, reinforce, frame, connect, or position the cover T and/or airbag module ABM; line TR may be formed in/around reinforcement structure RB.

According to an exemplary embodiment as indicated in FIGS. 7, 8A-8B, 12A-12B, 13A-13B, 20A-20H, 21A-21H, 22A-22E, 24, 25, 26 and 36A-36D, the cover T may provide the cover layer TX and/or an exterior/surface layer TC (e.g. film, coating, etc.); the cover T may provide the base layer TB and/or a substrate SB (e.g. structural substrate, pad, form, etc.). As indicated schematically in FIGS. 7 and 8A-8B, the cover T may comprise a surface effect; the surface effect may be provided by base layer TB and/or cover layer TX and/or surface layer TC and/or substrate SB; the surface effect may conceal or reduce visibility of the line TR at the exterior surface of cover T of component C. As indicated schematically in the FIGURES, the surface effect may comprise a contoured surface, textured surface, grained surface, leather-effect surface, stitched-effect surface, decorative surface, tactile surface, texture surface, stiff/soft surface, protective surface, etc. As indicated schematically in FIGS. 7 and 8A-8B, the seam/tear line TR comprising groove sections and/or features formed in cover T of composite structure CS of component C may be configured to be concealed within the surface effect at the exterior surface TC/TX of cover T (e.g. to reduce visual perception of the line at the exterior surface).

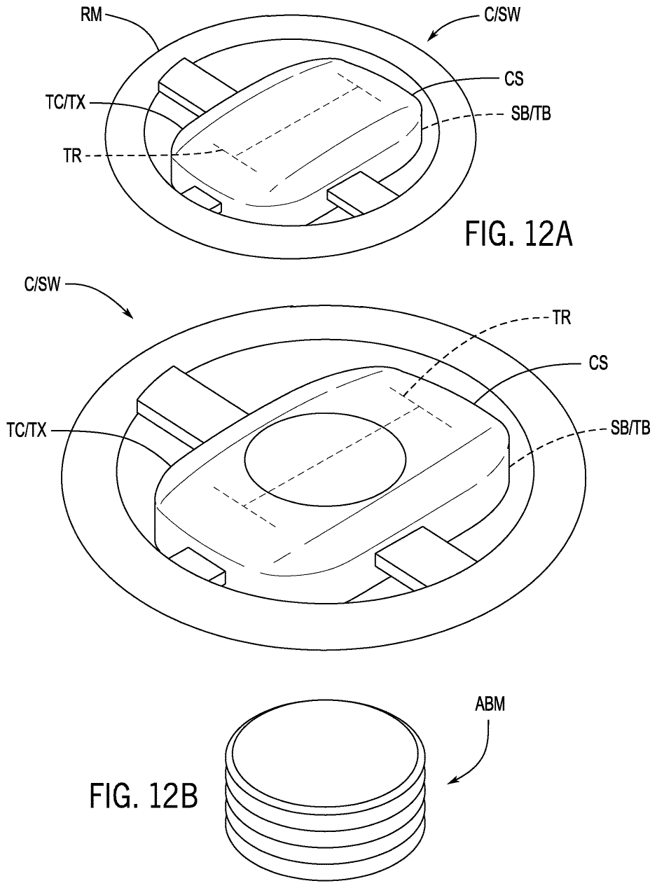

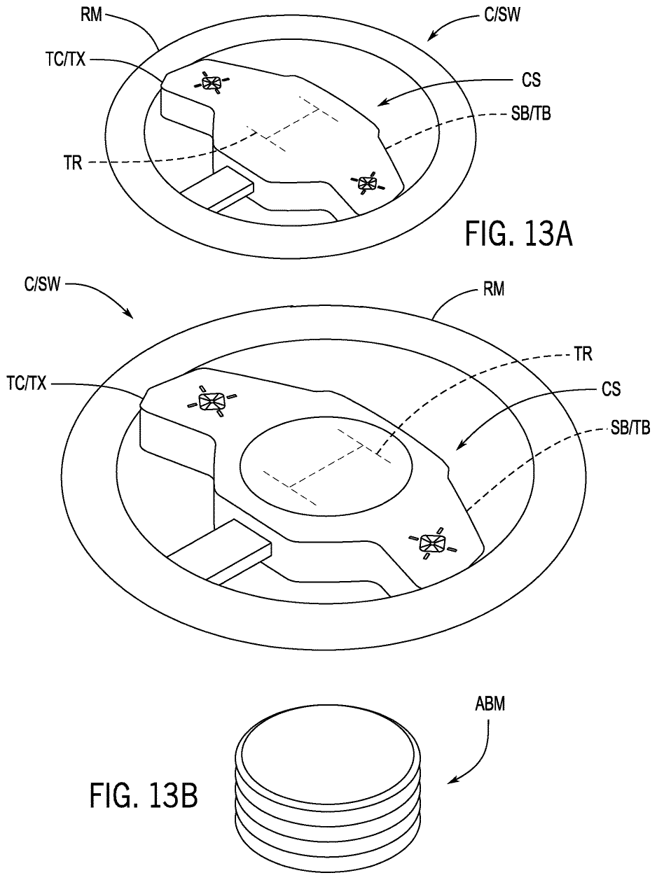

According to an exemplary embodiment in FIGS. 12A-12B and 13A-13B, composite structure CS may comprise the cover T with substrate/carrier SB and/or base layer TB and cover layer TX; substrate SB may provide structure for the cover T; base layer TB may comprise or be provided by the substrate SB; cover layer TX may be formed on the substrate SB and/or the base layer TB; cover layer TX may provide the exterior surface TC; cover T may comprise a molded cover; cover T may comprise a two-color/multi-color cover; cover T may be formed by injection molding, two-shot molding, multi-shot molding, double-color injection molding, overmolding, insert molding, etc., See also FIGS. 7, 8A-8B, 22A-22E, 23A-23C, 27, 31, 31A, 32, 32A, 33A-33B, 34A-34B, 35A-35C, 40, 42, 45, 45A-45B, 46, 48 and 48A. According to an exemplary embodiment in FIGS. 12A-12B and 13A-13B, composite structure CS may comprise the cover T with surface layer TC and cover layer TX and base layer TB and/or substrate SB; surface layer TC of cover T may comprise the exterior surface TC at cover layer TX and/or may may conceal or reduce perception of the tear line TR at the exterior surface of cover T. See also FIGS. 7 and 8A-8B.

According to an exemplary embodiment as shown schematically in the FIGURES, a component C may be configured to facilitate formation of an opening for deployment of an airbag into an interior VI of a vehicle V. The component may comprise a composite structure CS; the composite structure CS may comprise a cover T; the cover T may comprise a substrate SB; the substrate SB may comprise a base layer TB; the cover T may comprise a cover layer TX; the cover layer TX may be formed on the substrate SB and/or the base layer TB; the cover T may comprise an exterior surface TC; the exterior surface TC may be provided by the cover layer TX; the composite structure CS may comprise a line TR at a weakened area; the line TR may be configured to facilitate formation of the opening at the weakened area; the line may comprise a tear line TR; the line may comprise a set of features FT; each feature FT may comprise a profile; each feature FT may comprise a recess; the line may comprise a set of groove sections GR coupling features of the set of features FT.

According to an exemplary embodiment as indicated schematically in the FIGURES, a component C configured to facilitate formation of an opening for deployment of an airbag AB into an interior of a vehicle may comprise a composite structure CS comprising a cover T comprising a base layer TB and a cover layer TX; the composite structure CS may comprise a line TR at a weakened area for the cover T; the line TR is configured to facilitate formation of the opening at the weakened area for the cover T; the line TR may comprise a set of features FT configured to facilitate formation of the opening through the cover T; each feature FT of the set of features may comprise a profile.

According to an exemplary embodiment as indicated schematically in the FIGURES, each feature FT may comprise a recess comprising the profile in the cover T; the profile of the recess FT is at least partially formed into the base layer TB of the cover T; the line TR may comprise a seam and/or a tear line and/or a seam line and/or weakening line and/or a set of sections and/or a set of segments; the line TR may comprise a set of groove sections GR and the set of features FT; each feature FT of the set of features may comprise a recess adjacent to a groove section GR of the set of groove sections.

According to an exemplary embodiment as indicated schematically in the FIGURES, the feature FT may comprise a set of recesses; the line TR may comprise a set of groove sections GR; a recess FT of the set of recesses may be coupled to a groove section GR of the set of groove sections to provide the line TR as a weakening line at the weakened area of the cover T.

According to an exemplary embodiment as indicated schematically in the FIGURES, the set of features may comprise a pattern of features FT formed in the cover T; the pattern of features FT may be configured to form the line TR in the cover T as a weakening line TR at the weakened area; the set of features may comprise a pattern of recesses FT in the cover T; the line TR may comprise a tear line in the cover T provided by the pattern of recesses FT; the set of features may comprise a pattern of recesses FT formed in the cover T; the line TR may comprise a tear line TR formed in the cover T by the pattern of recesses FT. The line TR may comprise a groove in the base layer TB of the cover T; the groove of the line TR may comprise a profile; the profile of the groove of the line TR may comprise a U-shaped profile and/or a V-shaped profile and/or a multi-section profile.

According to an exemplary embodiment as indicated schematically in the FIGURES, the profile of a feature FT of the set of features may comprise a uniform-section profile and/or a multi-section profile and/or a tapered profile and/or a sloped section and/or a tip comprising a point and/or a tip at a closed section and/or a trapezoidal shaped profile and/or a U-shaped profile. Each feature FT may comprise a recess; the profile of the recess may comprise an open section and a closed section. The profile of each feature FT may comprise an open section formed into the base layer TB and a closed section at least partially formed into the base layer TB; the profile of each feature FT may comprise an open section formed into the base layer TB and a closed section at least partially formed into the cover layer TX. The line TR may comprise a set of groove sections GR; a profile of each groove section GR of the set of groove sections of the line TR may comprise a shape; the profile of each feature FT of the set of features of the line TR may comprise a shape different than the shape of the profile of each groove section GR of the set of groove sections of the line TR.

According to an exemplary embodiment as indicated schematically in the FIGURES, the composite structure CS may comprise a surface layer TC on the cover layer TX; the surface layer may comprise a film and/or a coating and/or an applied coating. The base layer TB may comprise an injection-molded substrate SB for the cover T (e.g. a panel, etc.); the cover layer TX may be formed on the base layer TB; the cover layer TX may comprise a molded material formed on the base layer TB. The feature may comprise a pattern of recesses FT formed in the cover T configured to form the line TR as a weakening line TR at the weakened area for the cover T; each recess FT of the pattern of recesses may comprise a generally V-shaped profile formed into the cover T to provide the weakening line TR at the weakened area for the cover T.

According to an exemplary embodiment as indicated schematically in the FIGURES, the cover T may be configured to provide a surface effect at an exterior surface of the cover layer TX and/or at surface layer TC; the surface effect may comprise a tactile effect and/or a texture effect and/or a color effect and/or a visual effect and/or a decorative effect and/or a protective effect and/or a concealment effect with the line generally visually imperceptible at the exterior surface (e.g. concealment of seam/tear line TR at exterior surface).

According to an exemplary embodiment as indicated schematically in the FIGURES, the component C may comprise a steering wheel assembly SW comprising a frame/rim RM and/or a trim component and/or a trim panel and or a trim panel for a steering wheel assembly; the composite structure CS may comprise an airbag chute CH and an airbag module ABM comprising the airbag AB. See FIGS. 2, 3, 4, 5A-5C, 6A-6C, 12A-12B, 13A-13B, 22A-22B and 23A-23B.

### EXEMPLARY EMBODIMENTS—A

According to an exemplary embodiment as shown in the FIGURES, a component configured to facilitate formation of an opening for deployment of an airbag into an interior of a vehicle may comprise a composite structure comprising a cover comprising a base layer and a cover layer; the composite structure may comprise a line at a weakened area for the cover; the line is configured to facilitate formation of the opening at the weakened area for the cover; the line may comprise a set of features configured to facilitate formation of the opening through the cover; each feature of the set of features may comprise a profile. Each feature may comprise a recess comprising the profile in the cover; the profile of the recess is at least partially formed into the base layer of the cover; the line may comprise a seam and/or a tear line and/or a seam line and/or weakening line and/or a set of sections and/or a set of segments; the line may comprise a set of groove sections and the set of features; each feature of the set of features may comprise a recess adjacent to a groove section of the set of groove sections. The set of features may comprise a pattern of features formed in the cover; the pattern of features is configured to form the line in the cover as a weakening line at the weakened area; the set of features may comprise a pattern of recesses in the cover; the line may comprise a tear line in the cover provided by the pattern of recesses; the set of features may comprise a pattern of recesses formed in the cover; the line may comprise a tear line formed in the cover by the pattern of recesses. The line may comprise a groove in the base layer of the cover; the groove of the line may comprise a profile; the profile of the groove of the line may comprise a U-shaped profile and/or a V-shaped profile and/or a multi-section profile. The profile of a feature of the set of features may comprise a uniform-section profile and/or a multi-section profile and/or a tapered profile and/or a sloped section and/or a tip comprising a point and/or a tip at a closed section and/or a trapezoidal shaped profile and/or a U-shaped profile. Each feature may comprise a recess; the profile of the recess may comprise an open section and a closed section. The profile of each feature may comprise an open section formed into the base layer and a closed section at least partially formed into the base layer; the profile of each feature may comprise an open section formed into the base layer and a closed section at least partially formed into the cover layer. The line may comprise a set of groove sections; a profile of each groove section of the set of groove sections of the line may comprise a shape; the profile of each feature of the set of features of the line may comprise a shape different than the shape of the profile of each groove section of the set of groove sections of the line. The composite structure may comprise a surface layer on the cover layer; the surface layer may comprise a film and/or a coating and/or an applied coating. The base layer may comprise an injection-molded substrate for the cover; the cover layer is formed on the base layer. The cover layer may comprise a molded material formed on the base layer. The feature may comprise a pattern of recesses configured to form the line as a weakening line at the weakened area for the cover; each recess of the pattern of recesses has a generally V-shaped profile formed into the cover to provide the weakening line at the weakened area for the cover. The feature may comprise a set of recesses; the line may comprise a set of groove sections; a recess of the set of recesses is coupled to a groove section of the set of groove sections to provide the line as a weakening line at the weakened area of the cover. The cover may be configured to provide a surface effect at an exterior surface of the cover layer; the surface effect may comprise a tactile effect and/or a texture effect and/or a color effect and/or a visual effect and/or a decorative effect and/or a protective effect and/or a concealment effect with the line generally visually imperceptible at the exterior surface. The component may comprise a steering wheel assembly and/or a trim component and/or a trim panel and or a trim panel for a steering wheel assembly; the composite structure may comprise an airbag chute and an airbag module comprising the airbag.

According to an exemplary embodiment as shown in the FIGURES, a component configured to facilitate formation of an opening for deployment of an airbag into an interior of a vehicle may comprise a composite structure comprising a cover comprising a base layer and a cover layer; the composite structure may comprise a line at a weakened area; the line is configured to facilitate formation of the opening at the weakened area; the line may comprise a set of features configured to facilitate formation of the opening; each feature of the set of features may comprise a profile. Each feature may comprise a recess comprising the profile. The line may comprise a seam and/or a tear line and/or a seam line and/or weakening line and/or a set of sections and/or a set of segments. The line may comprise a set of groove sections and the set of features; each feature of the set of features may comprise a recess adjacent to a groove section of the set of groove sections. The set of features may comprise a pattern of features formed in the cover; the pattern of features is configured to form the line in the cover as a weakening line at the weakened area. The set of features may comprise a pattern of recesses in the cover; the line may comprise a tear line in the cover provided by the pattern of recesses. The set of features may comprise a pattern of recesses formed in the cover; the line may comprise a tear line formed in the cover by the pattern of recesses. The line may comprise a groove in the base layer of the cover; the groove of the line may comprise a profile; the profile of the groove of the line may comprise a U-shaped profile and/or a V-shaped profile and/or a multi-section profile. The profile of a feature of the set of features may comprise a uniform-section profile and/or a multi-section profile and/or a tapered profile and/or a sloped section and/or a tip comprising a point and/or a tip at a closed section and/or a trapezoidal shaped profile and/or a U-shaped profile. The profile of the recess may comprise an open section and a closed section. The profile of the recess is at least partially formed into the base layer. The profile of the feature may comprise an open section formed into the base layer and a closed section at least partially formed into the base layer. The profile of the feature may comprise an open section formed into the base layer and a closed section at least partially formed into the cover layer. The line may comprise a set of groove sections; a profile of each groove section of the set of groove sections of the line may comprise a shape; the profile of each feature of the set of features of the line may comprise a shape different than the shape of the profile of each groove section of the set of groove sections of the line. The composite structure may comprise a surface layer on the cover layer; the surface layer may comprise a film and/or a coating and/or an applied coating. The base layer may comprise a substrate for the cover; the cover layer is formed on the base layer. The cover layer may comprise a cover layer material comprising a molded material formed on the base layer. The line may comprise a set of features formed in the base layer and in the cover layer. The feature may comprise a pattern of recesses configured to form the line as a weakening line at the weakened area of the cover; the pattern of recesses may comprise a U-shaped pattern and/or an H-shaped pattern. The feature may comprise a set of recesses; the line may comprise a set of groove sections; a recess of the set of recesses is coupled to a groove section of the set of groove sections to provide the line as a weakening line at the weakened area of the cover. The cover may be configured to provide a surface effect at an exterior surface of the cover layer; the surface effect may comprise a tactile effect and/or a texture effect and/or a color effect and/or a visual effect and/or a decorative effect and/or a protective effect. The cover may be configured to provide a surface effect at an exterior surface of the cover layer; the surface effect may comprise a tactile effect and/or a texture effect and/or a color effect and/or a visual effect and/or a decorative effect and/or a protective effect and/or a concealment effect with the line generally visually imperceptible at the exterior surface. The line may be configured to be generally visually imperceptible at an exterior surface of the cover layer. The component may comprise a steering wheel assembly and/or a trim component and/or a trim panel and or a trim panel for a steering wheel assembly; the composite structure may comprise an airbag chute and an airbag module comprising the airbag.

According to an exemplary embodiment, a component configured to facilitate formation of an opening for deployment of an airbag into an interior of a vehicle may comprise a composite structure comprising a cover comprising a base layer and cover layer; the composite structure may comprise a line at a weakened area configured to facilitate formation of the opening; the line may comprise a set of features; each feature may comprise a profile and/or a recess comprising the profile in the cover; the profile may be formed into the base layer and/or the cover layer; the line may comprise a seam and/or a tear line; the line may comprise a set of groove sections and the set of features. The base layer may comprise an injection-molded substrate; the cover layer may comprise a molded material formed on the base layer. The cover may be configured to provide a surface effect at an exterior surface of the cover layer; the surface effect may comprise a tactile effect and/or a texture effect and/or a color effect and/or a visual effect and/or a decorative effect and/or a protective effect and/or a concealment effect with the line generally visually imperceptible at the exterior surface. The component may comprise a steering wheel assembly and/or trim component; the composite structure may comprise an airbag chute and an airbag module comprising the airbag.

According to an exemplary embodiment, a component to facilitate formation of an opening for airbag deployment into a vehicle interior may comprise a composite structure comprising a cover with base layer and cover layer; the composite structure comprises a line at a weakened area for formation of the opening; the line may comprise a set of features; each feature comprises a profile and/or recess comprising the profile in the cover; the profile may be formed into base layer and/or cover layer; the line may comprise a seam/tear line; the line may comprise groove sections and features. Base layer may comprise a molded/formed substrate; cover layer may be molded/formed on base layer. The cover may provide a surface effect; the line may be visually imperceptible at the cover. The component may comprise a steering wheel assembly and/or trim component; the composite structure may comprise an airbag chute and airbag module comprising the airbag.

### EXEMPLARY EMBODIMENTS—B

According to an exemplary embodiment as shown schematically in the FIGURES, a component configured to facilitate formation of an opening for deployment of an airbag into an interior of a vehicle may comprise a composite structure comprising a cover comprising a base layer and a cover layer; the composite structure may comprise a line at a weakened area; the line may be configured to facilitate formation of the opening at the weakened area; the line may comprise a feature configured to facilitate formation of the opening; the feature may comprise a recess; the feature may comprise a set of features; the line may comprise the set of features; the set of features may comprise a pattern of features; the line may comprise a tear line; the line may comprise a seam; the line may comprise a set of sections to couple each feature of a set of features; each feature may comprise a profile; the profile may comprise a tapered profile; the profile may comprise a sloped section; the profile may comprise a set of sections; the profile may comprise a set of sections and a tip; the tip may comprise a closed section of the profile; the profile may comprise a trapezoidal shape; the profile may comprise a V-shaped profile; the profile may comprise a U-shaped profile; the profile may comprise a section formed into the cover; the profile may comprise an open section and a closed section formed into the cover; the profile may comprise an open section formed into the base layer of the cover; the profile may comprise a closed section formed into the base layer of the cover; the profile may be partially formed into the cover layer; the profile may comprise the closed section partially formed into the cover layer; the line may comprise a profile; the line may comprise a notch; each section of the line may comprise a profile; the profile of the line may comprise a groove-shaped profile; the profile of the line may comprise a U-shaped profile; the profile of the line may comprise a V-shaped profile; the profile of the line may be formed into the base layer; the profile of the line may comprise a shape; the profile of the feature may comprise a shape different than the profile of the line; the composite structure may comprise an airbag chute and an airbag module may comprise the airbag; the base layer may comprise a structural substrate for the cover; the cover may be formed by injection molding; the cover layer may be formed on the base layer; the base layer may comprise a base layer material; the cover layer may comprise a cover layer material; the base layer material may comprise an injection-molded material and the cover layer material may comprise an injection-molded material; the cover layer material may comprise a molded material formed on the base layer material; the base layer may comprise a color; the cover layer may comprise a color; the color of the base layer may be different than the color of the cover layer; the line may comprise a weakening line formed in the cover at the weakened area; the weakening line may be formed in the base layer and in the cover layer; the feature may comprise a pattern of recesses configured to form the line; the feature may comprise a set of groove sections coupling a set of features to provide the line as a weakening line at the weakened area of the cover; the line may be configured to be generally visually imperceptible at an exterior surface of the cover layer; the cover may be configured to provide a surface effect; the surface effect may comprise a visual effect at an exterior surface of the cover layer; the surface effect may comprise a tactile effect; the surface effect may comprise a protective effect; the surface effect may comprise a texture effect; the surface effect may comprise a color effect; the visual effect may comprise a decorative effect; the composite structure may comprise a surface layer on the cover layer; the surface layer may comprise a film and/or an applied coating; the component may comprise a steering wheel assembly and/or a trim component and/or a trim panel and or a trim panel for a steering wheel assembly.

According to an exemplary embodiment as shown schematically in the FIGURES, a component configured to facilitate formation of an opening for deployment of an airbag into an interior of a vehicle comprising a composite structure comprising cover comprising a base layer and a cover layer; the composite structure may comprise a line at a weakened area; the line may be configured to facilitate formation of the opening at the weakened area; the line may comprise a feature configured to facilitate formation of the opening; the feature may comprise a recess; the feature may comprise a set of features configured to form the line; the feature may comprise a set of features; the line may comprise the set of features; the set of features may comprise a pattern of features; the line may comprise a weakening line; the line may comprise a tear line; the line may comprise a seam; the line may comprise a groove; the line comprise a set of grooves; the line may comprise a section; the line may comprise a set of sections; the line may comprise a set of groove sections; the line may comprise a set of sections to couple each feature of a set of features; the composite structure may comprise a panel; the cover may comprise a panel; the component may comprise a steering wheel assembly; the composite structure may comprise a steering wheel assembly; the steering wheel assembly may comprise a frame; the steering wheel assembly may comprise an airbag module configured to provide the airbag; the steering wheel assembly may comprise a module configured to provide a user interface; the line may comprise a pattern; the pattern may comprise an H-shaped pattern; the pattern may comprise a U-shaped pattern; the line may comprise a seam; the seam may comprise a pattern; the seam may comprise an H-shape; the seam may comprise a U-shape; the seam may comprise a groove; the feature may comprise a groove; the feature may comprise a cavity; the feature may comprise a recess; the feature may comprise a profile; the feature may comprise a set of features; the set of features may comprise a set of recesses; the feature may comprise the set of recesses and a groove; the groove may be configured to couple a set of features; the seam may comprise a set of features; the seam may comprise groove comprising a set of features; the cover may comprise the line; the cover may comprise a groove; the cover may comprise the feature; the feature may be formed in the cover; the line may comprise a groove formed in the cover; the base layer of the cover may comprise the line; the line may be provided in the base layer of the cover; the line may be formed in the base layer of the cover; the line may comprise a set of features provided in the base layer of the cover; the line may comprise a set of features formed in the base layer of the cover; the line may comprise a set of features molded in the base layer of the cover; the line may comprise a set of features injected molded in the base layer of the cover; the line may comprise a set of features and a set of groove sections formed in the base layer of the cover; the feature may be formed in the base layer of the cover and the set of groove sections may be provided in the cover; the feature may be formed in the base layer of the cover and the cover layer of the cover; the feature may comprise a profile; each feature may comprise a profile; the profile may comprise a tapered profile; the profile may comprise a section; the profile may comprise an angled profile; the profile may comprise a sloped section; the profile may comprise a flat section; the profile may comprise a rounded section; the profile may comprise a contour; the profile may comprise a set of sections; the profile may comprise a ring-shaped section; the profile comprise a set of ring-shaped sections; the profile may comprise a set of sections and a tip; the profile may comprise a tip; the tip may comprise a closed section of the profile; the closed section of the profile may comprise a point; the profile may comprise a trapezoidal shape; the profile may comprise a V-shaped profile; the profile may comprise a U-shaped profile; the profile may comprise a symmetrical profile; the profile may comprise an asymmetrical profile; the profile may comprise an irregular-shaped profile; the profile may be formed into the cover; the profile may comprise a section formed into the cover; the profile may comprise an open section and a closed section formed into the cover; the profile may be formed into the base layer; the profile may comprise an open section; the profile may comprise an open section formed into the base layer of the cover; the profile may comprise a closed section formed into the base layer of the cover; the profile may be partially formed into the cover layer; the profile may comprise the closed section partially formed into the cover layer; the profile may comprise a residual section in the cover layer; the profile may comprise a residual depth in the cover layer; the line may comprise a profile; the line may comprise a notch; the line may comprise a symmetrical profile; the line may comprise an asymmetrical profile; each section of the line may comprise a profile; the profile of the line may comprise a groove-shaped profile; the profile of the line may comprise a U-shaped profile; the profile of the line may comprise a V-shaped profile; the profile of the line may be formed into the cover; the profile of the line may be formed into the base layer; the profile of the line may be partially formed into the cover layer; the profile of the line may comprise a shape; the profile of the feature may comprise a shape different than the profile of the line; the profile of the line may comprise a depth; the profile of the feature may comprise a depth larger than the profile of the line; the profile of the line may comprise a width; the profile of the feature may comprise a width larger than the profile of the line.

According to an exemplary embodiment as shown schematically in the FIGURES, a component configured to facilitate formation of an opening for deployment of an airbag into an interior of a vehicle comprising a composite structure comprising cover comprising a base layer and a cover layer; the composite structure may comprise a substrate; the composite structure may comprise a carrier; the composite structure may comprise a housing; the composite structure may comprise a chute; the housing may comprise a chute; the chute may comprise an airbag chute; the composite structure may comprise a steering wheel assembly comprising an airbag chute; the composite structure may comprise an airbag chute and an airbag module comprising the airbag; the cover may comprise a cover plate; the cover plate may comprise a panel; the composite structure may comprise a panel; the composite structure may comprise a structural substrate; the base layer may comprise a substrate; the base layer may comprise a structural substrate; the base layer may comprise a panel; the cover layer may comprise an exterior surface; the cover layer may comprise a skin layer; the base layer may comprise a structural layer; the base layer may comprise a structural substrate for the cover; the composite structure may comprise a molded structure; the cover may comprise a molded structure; the cover may comprise a molded layer; the cover may comprise a molded cover; the cover may be formed by injection molding; the cover layer may be formed on the base layer; the base layer may comprise a base layer material; the cover layer may comprise a cover layer material; the base layer material may be different than the cover layer material; the base layer material may comprise a polymer material; the cover layer material may comprise a polymer material; the base layer material may comprise an injection-molded material and the cover layer material may comprise an injection-molded material; the cover layer material may comprise a molded material formed on the base layer material; the base layer may comprise a color; the cover layer may comprise a color; the color of the base layer may be different than the color of the cover layer; the cover may comprise a two-color cover; the cover may comprise a multi-color cover; the line may comprise a weakening line formed in the cover at the weakened area; the weakening line may be formed in the base layer; the weakening line may be formed in the base layer and in the cover layer; the feature may comprise a pattern of recesses; the feature may comprise a pattern of recesses configured to form the line; the feature may comprise an aperture; the feature may comprise a set of apertures; the feature may comprise a hole; the feature may comprise a set of holes; the feature may comprise a pattern of features configured to provide the line as a weakening line at the weakened area of the cover; the feature may comprise a set of groove sections coupling a pattern of features to provide the line as a weakening line at the weakened area of the cover; the feature may comprise a set of groove sections coupling a set of features to provide the line as a weakening line at the weakened area of the cover; the line may be configured to be generally visually imperceptible at an exterior surface of the cover layer; the line may be configured to be generally tactically imperceptible at the cover layer; the line may be configured to be generally tactically imperceptible at an exterior surface of the cover layer; the line may be configured to be generally tactically imperceptible at the cover layer; the cover may be configured to provide a surface effect; the surface effect may comprise a visual effect at an exterior surface of the cover layer; the surface effect may comprise a tactile effect; the surface effect may comprise a protective effect; the surface effect may comprise a texture effect; the surface effect may comprise a color effect; the visual effect may comprise a decorative effect; the decorative effect may comprise a color effect; the decorative effect may comprise a grain effect; the decorative effect may comprise a leather effect; the composite structure may comprise a surface layer on the cover layer; the surface layer may comprise a coating on the cover layer; the coating may be configured to provide a surface effect for the cover; the surface layer may comprise a film and/or an applied coating; the composite structure comprise a contoured shape; the component may comprise a steering wheel assembly and/or a trim component and/or a trim panel and or a trim panel for a steering wheel assembly; the component may comprise a steering wheel assembly comprising an airbag module comprising the airbag.

According to an exemplary embodiment as shown schematically in the FIGURES, a component configured to facilitate formation of an opening for deployment of an airbag into an interior of a vehicle comprising a composite structure comprising cover comprising a base layer and a cover layer; the composite structure may comprise a line at a weakened area; the line may be configured to facilitate formation of the opening at the weakened area; the line may comprise a profile configured to facilitate formation of the opening; the line may comprise a molded line in the cover; the line may comprise a pattern configured to facilitate formation of the opening; the profile may comprise an open section formed in the base layer of the cover; the profile may comprise a closed section formed in the cover; the closed section of the profile may be formed in the cover layer of the cover; the line may comprise a set of features; the line may comprise a pattern of features; the line may comprise a set of groove sections; the set of groove features may be coupled to the set of features; each feature of the set of features may comprise a feature profile; each groove of the set of groove sections may comprise a groove profile; the cover of the composite structure may be formed by double-color injection molding of the cover layer onto the base layer; the cover may comprise an intermediate layer; the cover may comprise an interface layer; the cover may comprise a coating; the line may comprise a closed section and a depth and a residual thickness; each feature may comprise a closed section and a depth and a residual thickness; each feature may comprise a recess comprising a closed section and a depth and a residual thickness; each recess comprising a wall section; each groove section may comprise a closed section and a depth and a residual thickness; the line may comprise a seam groove in the cover configured to provide a tear path and/or a break line at the weakened area; the line may comprise a thinned region comprising a thickness reduction zone in the cover; the line may be configured to direct formation of the opening; the line may comprise a lower strength region and/or a rupture initiation region and/or a fracture initiation region and/or a deployment path and/or a force concentration region and/or a tear propagation section and/or a localized weakening section and/or a stress concentration region; the cover may comprise a resin material; the cover may comprise a resin structure; the cover may comprise a resin and/or a synthetic leather and/or a foam material and/or a molded resin and/or an injection molded material; the cover layer may comprise an overmolded material and/or a molded skin; the composite structure may comprise a molded substrate and/or a molded panel; the surface effect of the cover may comprise a stitched cover effect and/or a stitched seam effect and/or a decorative layer effect and/or a surface finish; the cover of the composite structure may comprise a cover plate for a steering wheel assembly; the cover layer may comprise a skin layer on an outer surface of the base layer; the base layer may comprise a skeleton layer; the line may comprise a weakening line configured on the cover plate; the weakening line comprising a tear-off section; the weakening line comprising an extension section connected to the tear-off section; the strength of the tear-off section may be less than strength of the extension section; the line may comprise a closed section and a residual thickness between the closed section and an exterior surface of the cover layer; the line may comprise a recessed feature configured to facilitate formation of the opening; the line may comprise a groove-connected set of features; the line may comprise a thickness reduction zone configured to provide a weakened section along the line; the line may comprise a deployment seam and/or a molded seam formed and/or symmetrical groove profile and/or an asymmetrical groove profile and/or a V-shaped pattern and/or an H-shaped pattern and/or a localized weakened region and/or a line of weakness and/or a molded line configured to rupture and/or a residual section configured to control tear propagation and/or a groove segment having a residual thickness less than an adjacent region and/or a recessed groove network; the composite structure may comprise a molded structure and/or a resin structure and/or a layered structure; the weakened area of cover may comprise the line configured to provide a weakened line and/or a weakened structure and/or a recessed structure and/or a groove structure and/or a seam structure and/or an interface structure for the weakened area and/or a residual structure in the weakened area and/or a transition structure; the cover may comprise a contour shape; the profile of the feature may comprise a contour; the feature may comprise a thickness transition zone and/or a localized weakening structure and/or fracture initiation geometry and or a reduced-thickness section and/or feature and/or a residual material bridge and/or a groove-connected recess and/or a multi-section profile and/or a molded tear geometry and/or a contour-controlled rupture path; the component may comprise a steering wheel assembly comprising an airbag module comprising an airbag.

### EXEMPLARY EMBODIMENTS—C

In view of the technical problems, the first aspect of the present application provides a cover plate/panel/layer of an airbag. The cover plate/panel/layer of the airbag comprises: a framework layer; and a skin layer; the skin layer is located on an outer surface of the framework layer and is integral with the framework layer; a weakening line is configured on the cover plate/panel/layer, and the strength of the weakening line is less than that of other parts of the cover plate/panel/layer; the weakening line comprises at least one tear-off section and at least one extension section connected to the tear-off section, and the strength of the tear-off section is less than the strength at the extension section.

A second aspect of the application provides a cover plate/panel/layer of an airbag. The cover plate/panel/layer of the airbag includes a skeleton layer; and a skin layer on an outer surface of the skeleton layer; the cover plate/panel/layer is formed by double-color injection molding, and a material of a first shot in the double-color injection molding is used to form one of a skeleton layer and a skin layer, and a material of the second shot is used to form the other of the skeleton layer and the skin layer; and a weakening line is constructed on the cover plate/panel/layer, and the strength of the weakening line is less than the strength of other parts of the cover plate/panel/layer.

According to an exemplary embodiment, the weakening line is injection molded with the skeleton layer and/or the skin layer.

According to an exemplary embodiment, the weakening line comprises at least one tear-off section and at least one extension section connected to the tear-off section, the strength at the tear-off section being less than the strength at the extension section.

According to an exemplary embodiment, there are a plurality of tear-off segments, a plurality of extension segments are provided, and the plurality of extension segments are spaced apart by the plurality of tear-off segments.

According to an exemplary embodiment, the weakening line includes two first weakening lines arranged opposite to each other and spaced apart from each other; Each first weakening line comprises a first middle section and two first extension sections respectively located on two sides of the first middle section; the weakening line comprises at least one second weakening line between the two first weakening lines; the second weakening line comprises a second middle section, two end sections and two second extension sections; each second extension section is connected to the second middle section and the corresponding end section, and the two end sections are respectively connected to the corresponding two first middle sections. The tear-off section includes two first middle sections, two end sections, and a second middle section; the extension section includes two first extension sections and two second extension sections.

According to an exemplary embodiment, the tear-off section is configured as a first groove; the first groove extends from the inner surface of the skeleton layer into the skin layer along the thickness direction of the cover plate/panel/layer, and the groove bottom of the first groove is spaced apart from the outer surface of the skin layer to form a first skin layer residual between the groove bottom of the first groove and the outer surface of the skin layer.

According to an exemplary embodiment, the first skin layer residual is between 0.1 mm and 1 mm.

According to an exemplary embodiment, a width of the groove bottom of the first groove is greater than 0 and less than or equal to 0.2 mm.

According to an exemplary embodiment, the first groove includes: a first groove section penetrating the skeleton layer in a thickness direction of the cover plate/panel/layer; and a second groove section extending from a groove bottom of the first groove section into the skin layer along a thickness direction of the cover plate/panel/layer, and a depth of the second groove section being less than a thickness of the skin layer; a notch width of the second groove section is less than or equal to a groove bottom width of the first groove section.

According to an exemplary embodiment, a width of a notch of the first groove section is greater than a width of a groove bottom of the first groove section; and/or a notch width of the second groove section is greater than a groove bottom width of the second groove section.

According to an exemplary embodiment, there is an interface between the skeleton layer and the skin layer; the extension segment includes a second groove extending from an inner surface of the skeleton layer into the skeleton layer in a thickness direction of the cover plate/panel/layer, and a bottom of the second groove is spaced apart from the interface.

According to an exemplary embodiment, the second groove is configured such that the notch width is greater than the groove bottom width.

According to an exemplary embodiment, the tear-off section comprises a plurality of first holes arranged in sequence along a longitudinal direction of the tear-off section and a third groove connected between adjacent first holes; the first hole extends from the inner surface of the skeleton layer into the skin layer along the thickness direction of the cover plate/panel/layer, and the hole bottom of the first hole is spaced apart from the outer surface of the skin layer to form a second skin layer residual between the hole bottom of the first hole and the outer surface of the skin layer; The third groove extends from the inner surface of the skeleton layer into the skin layer along the thickness direction of the cover plate/panel/layer, and the groove bottom of the third groove is spaced apart from the outer surface of the skin layer to form a third skin layer residual between the groove bottom of the third groove and the outer surface of the skin layer.

According to an exemplary embodiment, the third skin layer residual thickness is greater than the second skin layer residual thickness.

According to an exemplary embodiment, the second skin layer residual thickness is between 0.1 mm and 1 mm, and the third skin layer residual thickness is between 0.5 mm and 1.5 mm.

According to an exemplary embodiment, the area of the hole bottom of the first hole is between 0.1 mm and 0.6 mm, and the width of the groove bottom of the third groove is greater than 0 and less than or equal to 0.2 mm.

According to an exemplary embodiment, each first hole comprises at least two opposite first vertex angles, and a connection line between the first vertex angles extends longitudinally along the tear-off section; and the third groove is connected between opposite first vertex angles of two adjacent first holes.

According to an exemplary embodiment, the first hole includes: a first hole section penetrating the skeleton layer in a thickness direction of the cover plate/panel/layer; and a second hole section extending from the hole bottom of the first hole section into the skin layer along a thickness direction of the cover plate/panel/layer, and a depth of the second hole section being less than a thickness of the skin layer; an orifice area of the second hole section is less than or equal to a hole bottom area of the first hole section.

According to an exemplary embodiment, the aperture area of the first aperture section is greater than the aperture area of the first aperture section; and/or the aperture area of the second aperture section is greater than the aperture area of the second aperture section.

According to an exemplary embodiment, the side wall of the first hole section is configured to be stepped.

According to an exemplary embodiment, the third groove includes: a third groove section penetrating the skeleton layer along a thickness direction of the cover plate/panel/layer; and a fourth groove section extending from a groove bottom of the third groove into the skin layer along a thickness direction of the cover plate/panel/layer, and a depth of the fourth groove section being less than a thickness of the skin layer; a notch width of the fourth groove section is less than or equal to a groove bottom width of the third groove section.

According to an exemplary embodiment, the notch width of the third groove section is greater than the groove bottom width of the third groove section; and/or the notch width of the fourth groove section is greater than the groove bottom width of the fourth groove section.

According to an exemplary embodiment, a sidewall of the third slot segment is a smooth sidewall.

According to an exemplary embodiment, the extension segment includes a plurality of second holes, and the plurality of second holes are sequentially arranged at intervals along a longitudinal direction of the extension segment; There are a plurality of second grooves, and a second groove is connected between adjacent second holes; the second hole extends from the inner surface of the skeleton layer into the skin layer along the thickness direction of the cover plate/panel/layer, and the bottom of the second hole is spaced apart from the outer surface of the skin layer to form a fourth skin layer residual between the hole bottom of the second hole and the outer surface of the skin layer.

According to an exemplary embodiment, the fourth skin layer residual thickness is between 0.1 mm and 1 mm.

According to an exemplary embodiment, the hole bottom area of the second hole is between 0.1 mm and 0.6 mm.

According to an exemplary embodiment, each second hole comprises at least two opposite second vertex angles, and a connection line between the second vertex angles extends along a longitudinal direction of the extension segment; and the second trench is connected between opposite second vertex angles of two adjacent second holes.

According to an exemplary embodiment, the second hole includes: a third hole section penetrating the skeleton layer along a thickness direction of the cover plate/panel/layer; and a fourth hole section extending from the hole bottom of the third hole section into the skin layer along a thickness direction of the cover plate/panel/layer, and a depth of the fourth hole section being less than a thickness of the skin layer; an orifice area of the fourth hole section is less than or equal to a hole bottom area of the third hole section.

According to an exemplary embodiment, the aperture area of the third aperture section is greater than the aperture area of the third aperture section; and/or the aperture area of the fourth aperture section is greater than the aperture area of the fourth aperture section.

According to an exemplary embodiment, the peeling section includes: a fifth groove extending from the inner surface of the skeleton layer to the interior of the skeleton layer along the thickness direction of the cover plate/panel/layer. The groove bottom of the fifth groove is spaced apart from the interface of the skeleton layer and the skin layer; a skin layer inner groove formed at the interface; The inner groove of the skin layer extends into the skin layer along the thickness direction of the cover plate/panel/layer and is filled by the skeleton layer; the groove bottom of the inner groove of the skin layer is spaced apart from the outer surface of the skin layer to form a fifth skin layer residual thickness between the groove bottom of the inner groove of the skin layer and the outer surface of the skin layer; the groove bottom of the inner groove of the skin layer is in the range of the orthographic projection of the fifth groove facing the skin layer and deviates from the groove bottom of the fifth groove.

According to an exemplary embodiment, the fifth skin layer residual thickness is between 0.1 mm and 1.5 mm.

According to an exemplary embodiment, the lateral distance between the groove bottom of the skin layer inner groove and the groove bottom of the fifth groove is between 0.6 mm and 1.5 mm.

According to an exemplary embodiment, the fifth groove is configured such that the notch width is greater than the groove bottom width.

According to an exemplary embodiment, the tear-off section includes: a seventh groove; The seventh groove extends from the inner surface of the skeleton layer to the interior of the skeleton layer along the thickness direction of the cover plate/panel/layer, and the groove bottom of the seventh groove is spaced apart from the interface of the skeleton layer and the skin layer; and a thickness thinning area formed in the skin layer, the thickness reduction area being configured to gradually decrease from the two ends to the middle thickness along the width direction of the weakening line; and the orthographic projection of the seventh groove facing the skin layer is within the range of the thickness reduction area.

According to an exemplary embodiment, the thickness of the middle portion of the thickness thinned region is between 0.6 mm and 1 mm.

According to an exemplary embodiment, the thickness of the thickness thinned region decreases smoothly from both ends to the middle along the width direction of the weakening line.

According to an exemplary embodiment, the bottom of the seventh trench is directly opposite to the middle of the thickness thinned region.

According to an exemplary embodiment, the seventh groove is configured such that the notch width is greater than the groove bottom width.

According to an exemplary embodiment, the cover plate/panel/layer of the airbag includes a surface modification layer, and the surface modification layer is located on an outer surface of the skin layer.

According to an exemplary embodiment as indicated schematically in the FIGURES, the composite structure comprising the cover plate/panel/layer, the skeleton layer and the skin layer of the airbag are integrally formed; when the cover plate/panel/layer is manufactured, a separate operation form skin and the adhesive for covering the cover plate/panel/layer body is not required (e.g. efficiency can be achieved to reduce the manufacturing cost of the cover plate/panel/layer). According to an exemplary embodiment, the tear-off section and the extension section are both strength weak areas on the cover plate/panel/layer, and the strength of the tear-off section is less than the strength of the extension section. According to an exemplary embodiment, when the airbag is inflated and expanded, the cover plate/panel/layer first generates a crack at the tear-off section under the impact of the airbag, and the crack rapidly expands along the extension section, so that the cover plate/panel/layer is split, so that the airbag can be quickly ejected. According to an exemplary embodiment, the cover is split by a predetermined trajectory (i.e. weakening line). According to an exemplary embodiment, the configuration of the composite structure allows the cover plate/panel/layer to be split in a controllable manner to avoid generating spatter helping to improve the safety of the cover plate/panel/layer.

According to an exemplary embodiment, the term “outer” refers to a direction inside a vehicle, and the term “inner” refers to a direction opposite to “outer”. In other words, the passenger or driver may see the outer surface of the cover plate/panel/layer (or skin layer) and see the inner surface of the cover plate/panel/layer (or skeleton layer).

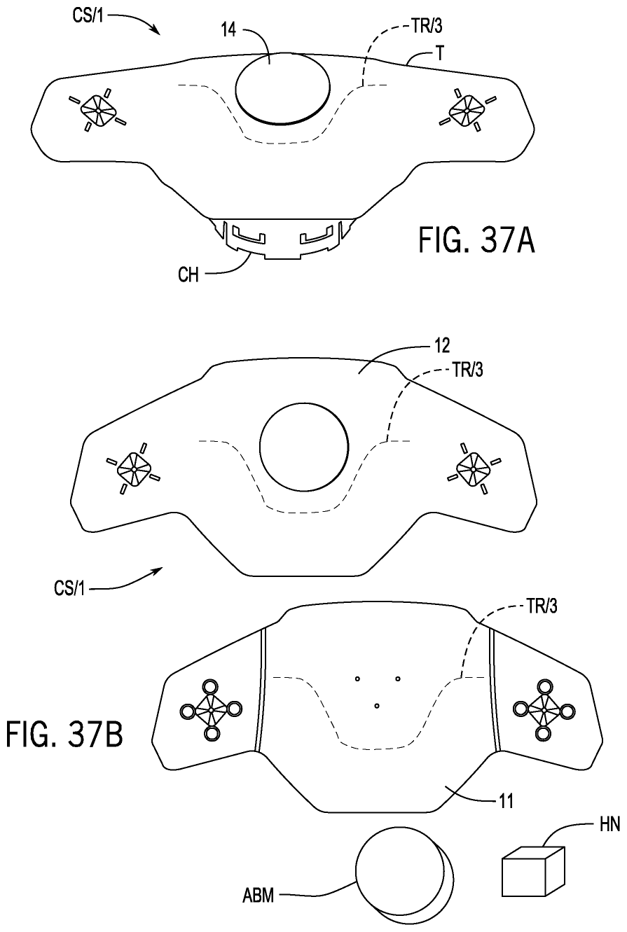

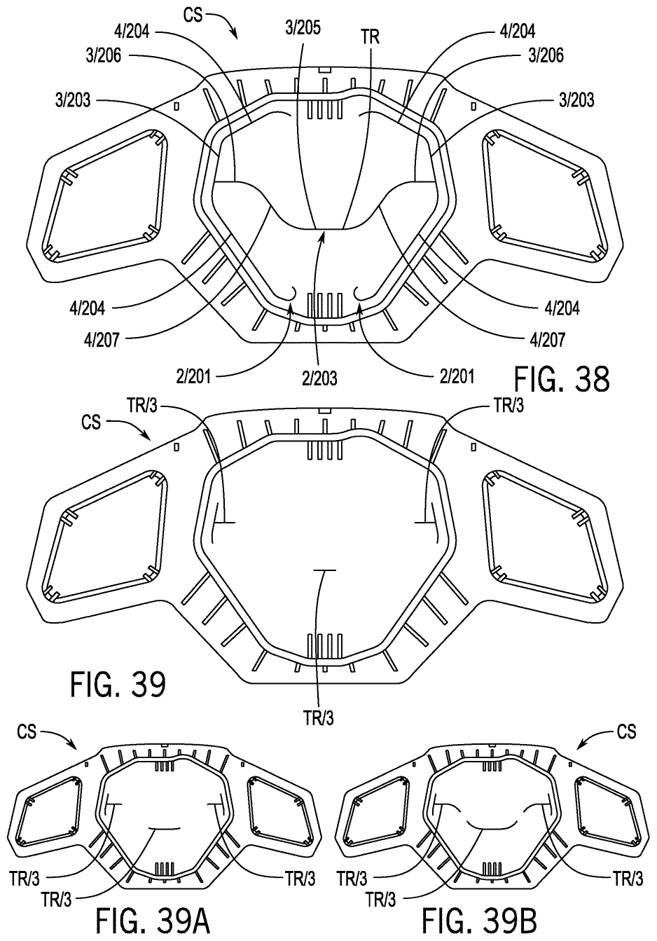

According to an exemplary embodiment as shown schematically in FIGS. 37A and 37B, a cover plate/panel/layer 1 of an airbag comprises a skeleton layer 11 and a skin layer 12 skin layer 12 on the outer surface of the skeleton layer 11 and integral with the skeleton layer 11. According to an exemplary embodiment as shown schematically in FIG. 38, the strength of the weakening line 2 of the weakening line 2 is less than the strength of other parts of the cover plate/panel/layer 1 on the cover plate/panel/layer 1. The weakening line 2 comprises at least one tear-off section 3 and at least one extension section 4 extension section 4 connected to the tear-off section 3, and the strength at the tear-off section 3 is less than the strength at the extension section 4.

The cover plate/panel/layer 1, the skeleton layer 11 and the skin layer 12 according to the present application are integrated. When the cover plate/panel/layer 1 is manufactured, it is not necessary to prepare the skin and the adhesive for covering the plate/panel/layer body as in the prior art, and there is no need to cover the skin covering operation in the prior art. According to an exemplary embodiment, the configuration of the composite structure helps to reduce the manufacturing cost of the cover plate/panel/layer 1.

According to an exemplary embodiment, when the airbag (not shown in the figure) is inflated and opened, under the impact of the airbag, a crack is first generated at the tear-off section 3 of the cover plate/panel/layer 1, and then the crack is rapidly expanded along the extension section 4, so that the cover plate/panel/layer 1 is split along the weakening line 2, so that the airbag can be quickly ejected. In other words, the cover plate/panel/layer 1 is split by a predetermined trajectory (i.e. weakening line 2) under the impact of the airbag. According to an exemplary embodiment, the configuration of the composite structure enables the split mode of the cover plate/panel/layer 1 to be controlled to avoid generating spatter helping to improve the safety of the cover plate/panel/layer 1.

According to an exemplary embodiment, the weakening line 2 is offset from the span 14 on the cover plate/panel/layer 1 in order to reduce potential/possibility of the span 14 flying when the cover plate/panel/layer 1 breaks.

According to an exemplary embodiment as shown schematically in FIG. 37A, the shape of the cover plate/panel/layer 1 is adapted to a vehicle steering wheel (not shown) for mounting on a vehicle steering wheel. The cover plate/panel/layer 1 of the airbag may be configured in other shapes, so as to be suitable for being mounted at other positions of the vehicle, for example, used as an instrument panel or the like. According to an exemplary embodiment, the technical solution of the present application is described below by taking the cover plate/panel/layer 1 adapted to be mounted on the steering wheel as an example.

According to an exemplary embodiment, the cover plate/panel/layer 1 is formed by two-color injection molding. According to an exemplary embodiment, the skeleton layer 11 and the skin layer 12 will be well bonded together. When the cover plate/panel/layer 1 is split, the skeleton layer 11 and the skin layer 12 will crack at the same time without delamination, which helps to avoid generating spatter improving the safety of the cover plate/panel/layer 1.

According to an exemplary embodiment, during a two-color injection molding process the material used for the first shot is used to form one of the skeleton layer 11 and the skin layer 12, and the material used for the second shot is used to form the other of the skeleton layer 11 and the skin layer 12. According to an exemplary embodiment, the material used for the first injection is TPEE (thermoplastic polyester elastomer), and the material used for forming the second injection of the framework layer 11 may be TPEE, which is used for forming the double-color injection molding process of the skin layer 12 on the framework layer 11, which is simpler than the coating process in the prior art, and the required time is shorter, which helps to reduce the manufacturing cost of the cover plate/panel/layer 1 and improve the production efficiency of the cover plate/panel/layer 1. According to an exemplary embodiment, other materials may be used to manufacture the cover plate/panel/layer 1 according to actual situations, such as using TPE (thermoplastic elastomer) or TPO (thermoplastic polyolefin), etc. A person skilled in the art may form the cover plate/panel/layer 1 in other manners is as indicated schematically in the FIGURES.

According to an exemplary embodiment, the structure of forming the weakening line 2 is configured on an injection mold. According to an exemplary embodiment, when the cover plate/panel/layer 1 is injection molded, the weakening line 2 is formed at the same time, which is easily implemented by a person skilled in the art is as indicated schematically in the FIGURES. According to an exemplary embodiment, it is well known to those skilled in the art to use cold knife weakening or laser weakening in the prior art to form a weakening line 2 cold knife weakening or laser weakening on the cover plate/panel/layer 1 according to needs is as indicated schematically in the FIGURES.

According to an exemplary embodiment, the skeleton layer 1 may have a larger thickness and a higher strength to serve as a support structure for the cover plate/panel/layer 1. Generally, the thickness S of the skeleton layer 11 is greater than the thickness L of the skin layer 12, for example, the thickness S of the skeleton layer 11 may be between 1 mm and 5 mm; the thickness L of the skin layer 12 is between 0.5 mm and 3 mm. Certainly, the thickness of the skeleton layer 1 and the thickness of the skin layer 12 may be other numerical ranges, which are not limited. The structure of the weakening line 2 on the cover plate/panel/layer 1 is described below.

Composite Structure/Cover with Line/Seam-Exemplary Embodiment

According to an exemplary embodiment as shown schematically in FIG. 38, the weakening line 2 includes two first weakening lines 201 arranged opposite to each other and spaced apart from each other, and two first weakening lines 201 connected between the two first weakening lines 201 are not connected to each other. In particular, each first weakening line 201 comprises a first middle section 203 and two first extension sections 204, 204 at two sides of the first middle section 203, comprising a second middle section 205, two end sections 206 and two second extension sections 207 connected between the second middle section 205 and the respective end section 206, and the two end sections 206 are respectively connected to the respective two first middle sections 203. In this configuration, the tear-off section 3 comprises two first middle sections 203, two end sections 206 and a second middle section 205; The extension segment 4 includes two first extension segments 204 and two second extension segments 207, so that when the cover plate/panel/layer 1 is impacted by the airbag 1 in the middle of the first weakening line 201 and the second weakening line 202, these weakening lines almost simultaneously generate cracks and the cracks rapidly expand along the corresponding weakening lines accelerating the cracking speed of the cover plate/panel/layer 1, and the airbag can be ejected more quickly.

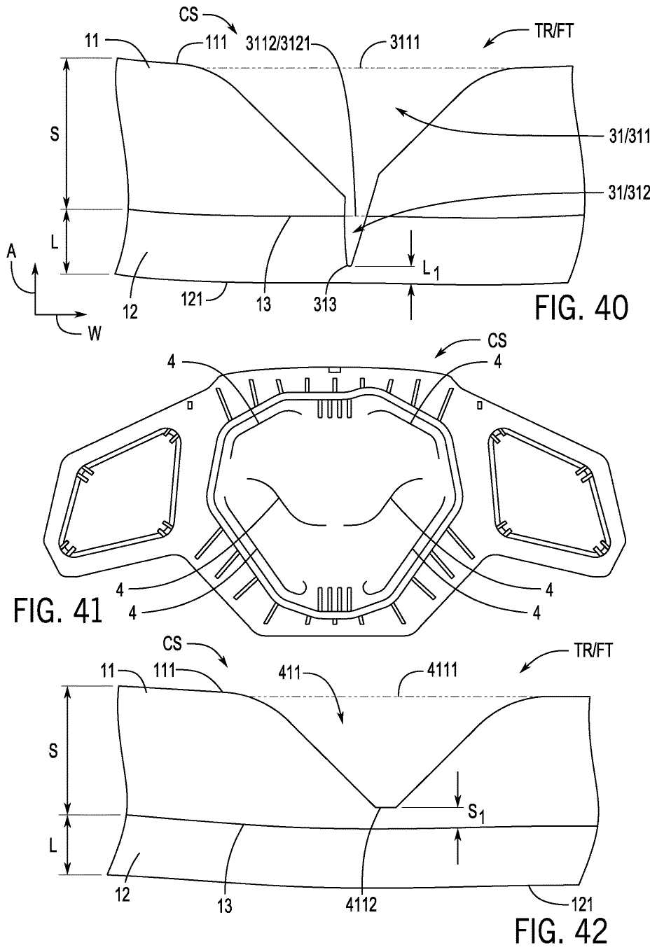

According to an exemplary embodiment as shown schematically in FIGS. 39, 39A, 39B, and 40, the peeling section 3 is configured such that the first groove 31 extends from the inner surface 111 of the skeleton layer 11 into the skin layer 12 along the thickness direction A of the cover plate/panel/layer 1. The groove bottom 313 of the first groove 31 is spaced apart from the outer surface 121 of the skin layer 12 such that a first skin layer residual L1 is formed between the groove bottom 313 of the first groove and the outer surface 121 of the skin layer 12 as a whole, the skeleton layer 11 is turned on, and the thickness of the respective part of the skin layer 12 is reduced, which makes the strength at the tear-off section 3 smaller. From the whole, the tear-off section 3 forms the strength weak area of the cover plate/panel/layer 1. According to an exemplary embodiment, when the cover plate/panel/layer 1 is impacted by the airbag, a crack is easily generated at the tear-off section 3. According to an exemplary embodiment, from the entirety of the cover plate/panel/layer 1, the skin layer 12 remains intact, which helps to improve the esthetics of the cover plate/panel/layer 1.

According to an exemplary embodiment, the first skin layer residual L1 is between 0.1 mm and 1 mm. According to an exemplary embodiment, the first skin layer residual L1 is small, and the strength is weak and easy to tear. According to an exemplary embodiment, it has been found that this size of the first skin layer residual L1 does not cause a depression (i.e. a weakened imprint) on the outer surface of the skin layer 12 that corresponds to the first groove 31 even after the skin layer 12 is subjected to long-term high temperature and/or sun-broil baking, which helps to improve the esthetics of the cover plate/panel/layer 1. According to an exemplary embodiment, the first skin layer residual L1 may be between 0.2 mm and 0.8 mm. According to an exemplary embodiment, the first skin layer residual L1 may be configured as another value according to the actual situation.

According to an exemplary embodiment, a width of the groove bottom 313 of the first groove 31 is greater than 0 and less than or equal to 0.2 mm. According to an exemplary embodiment, the width of the groove bottom 313 of the first groove 31 is small. After aging of the skin layer 12, it is not easy to produce a weakened print or a weakened print corresponding to the first groove 31 on the skin layer 12 helping to improve the esthetics of the cover plate/panel/layer 1.

According to an exemplary embodiment as shown schematically in FIG. 40, the first groove 31 comprises a first groove section 311 and a second groove section 312 the first groove section 311 passes through the skeleton layer 11 in the thickness direction A of the cover plate/panel/layer 1, the first groove section 311 has a notch 3111 at the inner surface 111 of the skeleton layer 11 and the groove bottom 3112 at the interface 13 of the skeleton layer 11 and the skin layer 12 extends from the groove bottom 3111 of the first groove section 311 into the skin layer 12 along the thickness direction A of the cover plate/panel/layer 1. The depth of the second groove section 312 is less than the thickness L of the skin layer 12 to form the first skin layer residual L1 second groove section 312 of the foregoing having the groove bottom 313 of the notch 3121 first groove 31 at the interface 13 forming the groove bottom of the second groove section 312. The width of the slot 3121 of the second slot segment 312 is equal to the width of the slot bottom 3112 of the first slot segment 311. According to an exemplary embodiment, along the thickness direction A of the cover plate/panel/layer 1, the first groove is continuous, which facilitates the formation of the first groove while the cover plate/panel/layer 1 is injection molded. According to an exemplary embodiment, the width of the slot 3121 of the second slot segment 312 may be smaller than the width of the slot bottom 3112 of the first slot segment 311.

According to an exemplary embodiment as shown schematically in FIG. 40, a width of the notch 3111 of the first groove section 311 is greater than a width of the groove bottom 3112 of the first groove section 311. According to an exemplary embodiment, the cross-section of the first slot segment 311 is generally trapezoidal. According to this structure, the thickness variation of the skeleton layer 11 at the first slot segment 311 is relatively gentle. During injection molding, the region around the first slot segment 311 is not prone to injection molding defects, so that the quality of the skin layer 12 formed on the skeleton layer 11 and the form of the outer surface 121 of the skin layer 12 are better, which helps to improve the aesthetics of the cover plate/panel/layer 1. According to an exemplary embodiment, the cross-section of the first slot segment 311 may be other suitable shapes. According to an exemplary embodiment, the configuration of the composite structure for the second slot segment 312 is as indicated schematically in the FIGURES.

According to an exemplary embodiment, the width of the slot 3111 of the first slot segment 311 is between 7 mm and 10 mm; the width of the slot bottom 3112 of the first slot segment 311 is between 0.4 mm and 0.7 mm. A width of the notch 3121 of the second slot segment 312 is between 0.4 mm and 0.7 mm. The first slot segment 311 and the second slot segment 312 of this size facilitate injection molding.

According to an exemplary embodiment as shown schematically in FIGS. 41 and 42, the extension section 4 is configured such that the second groove 411 extends from the inner surface 111 of the skeleton layer 11 into the skeleton layer 11 along the thickness direction A of the cover plate/panel/layer 1. According to an exemplary embodiment, the second groove 411 has a notch 4111 on the inner surface 111 of the skeleton layer 11 and a groove bottom 4112 of the groove bottom 4112 second groove 411 in the skeleton layer 11 spaced apart from the interface 13 of the skeleton layer 11 and the skin layer 12, whereby a first skeleton layer residual S1 is formed between the groove bottom 4112 of the second groove 411 and the interface 13 as a whole, the thickness at the second groove 411 (or extension section 4) is thin, the strength is small, and the weak area of the cover plate/panel/layer 1 is formed. When the cover plate/panel/layer 1 is impacted by the airbag, cracks generated in the tear-off section 3 can be rapidly expanded along the extension section 4, and finally the cover plate/panel/layer 1 is split. The second trench 411 (or extension segment 4) does not penetrate through the skeleton layer 11, so the strength at the second trench 411 (or extension segment 4) is greater than the strength at the tear-off segment 3.

According to an exemplary embodiment, since the skeleton layer 11 is not penetrated by the second groove 411 at the extension section 4, the part of the skin layer 12 corresponding to the extension section 4 will obtain a good support of the skeleton layer 11. When the skin layer 12 is aged, the outer surface 121 of the skin layer 12 is not easy to produce a weakened print corresponding to the second groove 411 (or the extension section 4) helping to improve the aesthetics of the cover plate/panel/layer 1. According to an exemplary embodiment, the extension segments 4 space these tear-off segments 3. According to an exemplary embodiment, from the overall view of the cover plate/panel/layer 1, the skeleton layer 11 is only penetrated at several tear-off sections 3 which are separated from each other. According to an exemplary embodiment, the configuration of the composite structure helps to avoid an excessively small overall strength of the cover plate/panel/layer 1 avoiding accidental damage to the cover plate/panel/layer 1.

According to an exemplary embodiment, the first skeleton layer residual S1 is between 0.1 mm and 1 mm. According to an exemplary embodiment, the first skeleton layer residual S1 is between 0.2 mm and 0.8 mm.

According to an exemplary embodiment as shown schematically in FIG. 42, the width of the notch 4111 of the second groove 411 is greater than the width of the groove bottom 4112 of the second groove 411. According to an exemplary embodiment, the cross section of the second groove 411 is generally V-shaped. Similar to the first groove segment 311 of the first groove 31, during injection molding, the region around the second groove 411 is not prone to injection molding defects, which helps to make the shape of the skin layer 12 formed on the skeleton layer 11 and the form of the outer surface 121 of the skin layer 12 better helping to improve the aesthetics of the cover plate/panel/layer 1. According to an exemplary embodiment, the cross section of the second groove 411 may be trapezoidal or other suitable shape. According to an exemplary embodiment, the width of the notch 4111 of the second groove 411 is between 6 mm and 10 mm, and the width of the groove bottom 4112 is between 0.4 mm and 0.7 mm.

Composite Structure/Cover with Line/Seam-Exemplary Embodiment

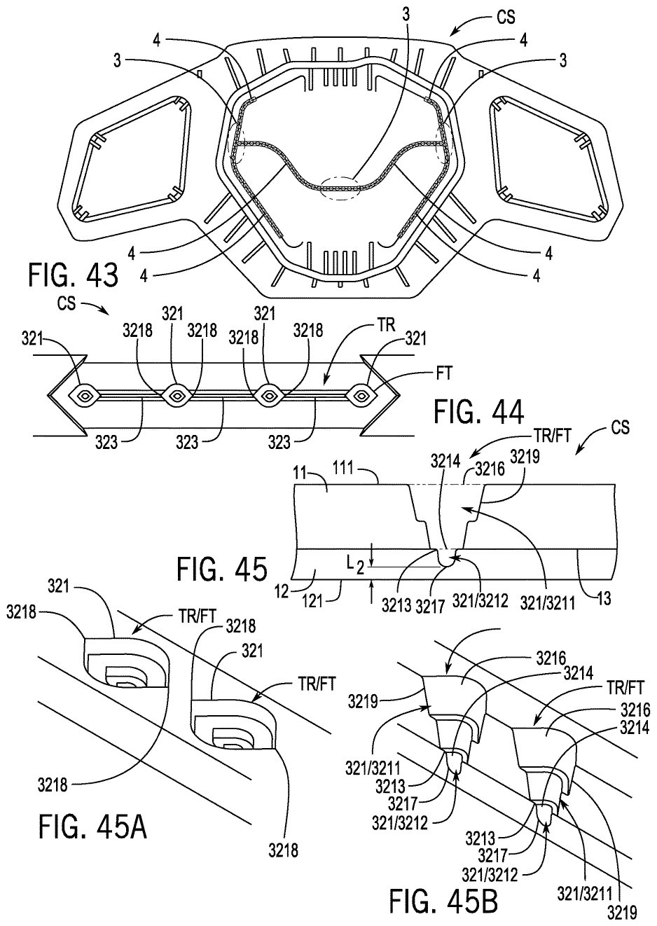

According to an exemplary embodiment as shown schematically in FIGS. 38 and 43, the weakening line of an exemplary embodiment is similar to the weakening line of an exemplary embodiment as a whole, and only the differences between the two are described below.

According to an exemplary embodiment as shown schematically in FIG. 44, the tear-off section 3 includes a plurality of first holes 321, which are arranged in sequence along the longitudinal direction of the tear-off section 3. The tear-off section 3 comprises a third groove 323 connected between adjacent first holes 321 in the present application, and the longitudinal direction of the tear-off section 3 refers to a direction generally parallel to the length direction of the tear-off section.

According to an exemplary embodiment as shown schematically in FIG. 45, the first aperture 321 extends from the inner surface 111 of the skeleton layer 11 along the thickness direction A of the cover plate/panel/layer 1 into the skin layer 12. According to an exemplary embodiment, the first aperture 321 has an aperture 3216 in the inner surface 111 of the skeleton layer 11 and an aperture bottom 3217 in the aperture bottom 3217 of the skin layer 12 spaced apart from the outer surface 121 of the skin layer 12 forming a second skin layer residual L2 between the aperture bottom 3217 of the first aperture 321 and the outer surface 121 of the skin layer 12.

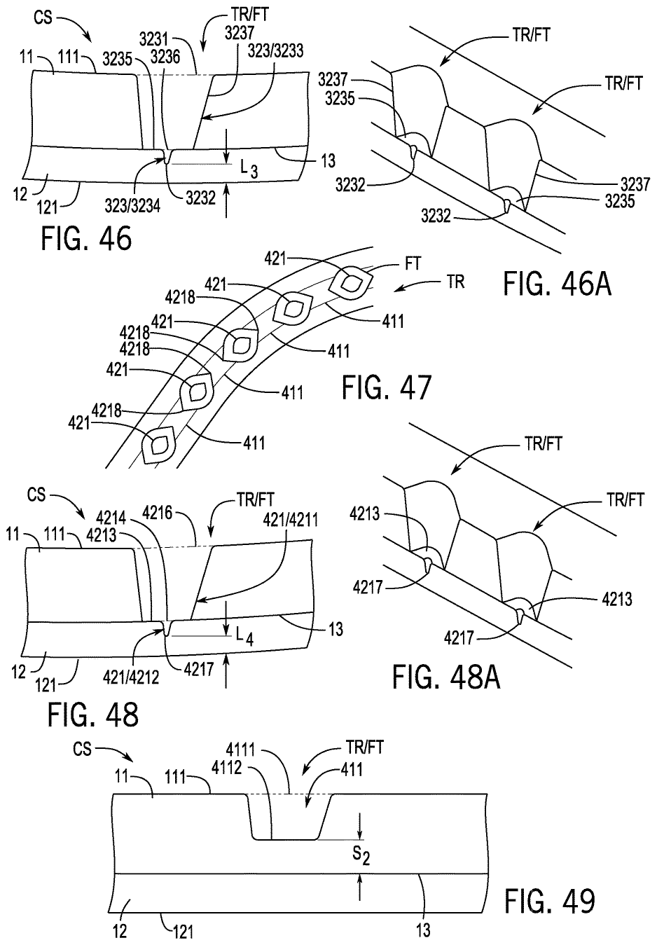

According to an exemplary embodiment as shown schematically in FIG. 46, the third groove 323 extends from the inner surface 111 of the skeleton layer 11 along the thickness direction A of the cover plate/panel/layer 1 into the skin layer 12. According to an exemplary embodiment, the third groove 323 has a notch 3231 in the inner surface 111 of the skeleton layer 11 and a groove bottom 3232 of the groove bottom 3232 third groove 323 within the skin layer 12 spaced apart from the outer surface 121 of the skin layer 12 forming a third skin layer residual L3 between the groove bottom 3232 of the third groove 323 and the outer surface 121 of the skin layer 12

As a whole from the cover plate/panel/layer 1, in the entire tear-off section 3, the skeleton layer 11 is opened and the thickness of the respective portion of the skin layer 12 is reduced, which makes the strength at the tear-off section 3 smaller. When the cover plate/panel/layer 1 is impacted by the airbag, cracks can be easily generated at the tear-off section 3. According to an exemplary embodiment, from the entirety of the cover plate/panel/layer 1, the outer surface 121 of the skin layer 12 remains intact, which helps to improve the esthetics of the cover plate/panel/layer 1.

According to an exemplary embodiment, the third skin layer residual L3 may be greater than the second skin layer residual L2, and the strength of the portion of the skin layer 12 corresponding to the third trench 323 may be greater than the strength of the portion of the skin layer 12 corresponding to the first hole 321. According to an exemplary embodiment, when the skin layer 12 is aged, the part of the skin layer 12 corresponding to the third groove 323 pulls the part of the skin layer 12 corresponding to the first hole 321, so that a weakening mark corresponding to the tear-off section 3 is not easily generated on the outer surface 121 of the skin layer 12 or cannot be easily observed improving the appearance quality of the cover plate/panel/layer 1. According to an exemplary embodiment, the second skin layer residual L2 is between 0.1 mm and 1 mm; preferably between 0.2 mm and 0.8 mm; the third skin layer residual L3 is between 0.5 mm and 1.5 mm, preferably between 0.6 mm and 1.0 mm.

According to an exemplary embodiment, the area of the aperture bottom 3217 of the first aperture 321 is between 0.1 mm and 0.6 mm. A width of the groove bottom 3232 of the third groove 323 is greater than 0 and less than or equal to 0.2 mm. According to an exemplary embodiment, the area of the aperture bottom 3217 of the first aperture 321 is smaller and the width of the groove bottom 3232 of the third groove 323 is small. After aging of the skin layer 12, the outer surface 121 of the skin layer 12 is not easy to produce a weakened or weakened footprint corresponding to the first and third grooves 321, 323 helping to improve the esthetics of the cover plate/panel/layer 1.

According to an exemplary embodiment as shown schematically in FIG. 44, each first hole 321 comprises at least two opposite first vertex angles 3218, and a connection line between these first vertex angles 3218 extends along the longitudinal direction of the tear-off section 3. The third groove 323 is connected between the opposite first apex angles 3218 of the two adjacent first apertures 321. According to an exemplary embodiment, the first apex angle 3218 is sharper than the other portions of the first aperture 321. When the cover plate/panel/layer 1 is impacted by the airbag, a large stress concentration will be generated at the first vertex angle 3218 of the first hole 321 making it easier to quickly generate cracks at the first vertex angle 3218. According to an exemplary embodiment, the first hole 321 may be generally a rhombus, and certainly may be other shapes, for example, an ellipse.

According to an exemplary embodiment as shown schematically in FIG. 45, the first aperture 321 comprises a first aperture segment 3211 and a second aperture segment 3212, the first aperture segment 3211 passing through the skeleton layer 11 in the thickness direction A of the cover plate/panel/layer 1, the first aperture segment 3211 having a hole bottom 3213 at the interface 13 of the skeleton layer 11 and the skin layer 12, and the aperture 3216 of the first aperture 321 forming the aperture of the first aperture segment 3211. The second aperture segment 3212 extends along the thickness direction A of the cover plate/panel/layer 1 from the aperture bottom 3213 of the first aperture segment 3211 into the skin layer 12. According to an exemplary embodiment, the second aperture segment 3212 has an aperture 3214 at the interface 13 of the skeleton layer 11 and the skin layer 12, while the aperture bottom 3217 of the first aperture forms the aperture of the second aperture segment 3212. The depth of the second aperture segment 3212 is less than the thickness L of the skin layer 12 to form the second skin layer residual L2 above, the area of the aperture 3212 of the second aperture segment 3212 being smaller than or equal to the area of the aperture bottom 3213 of the first aperture segment 3211. According to an exemplary embodiment, from the whole, the first aperture 321 is continuous, which facilitates the formation of the first aperture 321 while the cover panel 1 is injection molded.

According to an exemplary embodiment as shown in FIG. 45, the area of the aperture of the first hole section 3211 is larger than the area of the aperture bottom 3213. According to an exemplary embodiment, the thickness change of the skeleton layer 11 at the first hole section 3211 is relatively smooth. During injection molding, the area around the first hole section 3211 is not prone to injection molding defects, so that the quality of the skin layer 12 formed on the skeleton layer 11 and the form of the outer surface 121 of the skin layer 12 are good, which helps to improve the aesthetics of the cover plate/panel/layer 1. According to an exemplary embodiment, the side wall 3219 of the first hole section 3211 forms a stepped shape (the entire first hole section 3211 forms a stepped hole) (as shown schematically in FIG. 45) or may be configured in other appropriate shapes. According to an exemplary embodiment, the configuration of the composite structure for the second hole segment 3212 is as indicated schematically in the FIGURES.

According to an exemplary embodiment, the area of the aperture of the first aperture segment 3211 (i.e. the aperture 3216 of the first aperture) is between 1.5 mm and 2.2 mm, and the area of the aperture bottom 3213 of the first aperture segment 3211 is between 0.4 mm and 0.6 mm. The area of the aperture 3214 of the second aperture segment 3212 is between 0.4 mm and 0.6 mm. The first aperture segment 3211 and the second aperture segment 3212 of this size facilitate injection molding. According to an exemplary embodiment, the area of the respective orifices of the first hole section 3211 and the area of the hole bottom may be set to other values according to the actual situation.

According to an exemplary embodiment as shown schematically in FIG. 46, the third groove 323 comprises a third groove section 3233 and a fourth groove section 3234 through the skeleton layer 11 along the thickness direction A of the cover plate/panel/layer 1, the third groove section 3233 has a groove bottom 3235 at the interface 13 of the skeleton layer 11 and the skin layer 12, and the notch 3231 of the third groove forms the notch of the third groove section 3233. The fourth groove segment 3234 extends along the thickness direction A of the cover plate/panel/layer 1 from the groove bottom G of the third groove 3233 into the skin layer 12. According to an exemplary embodiment, the fourth slot segment 3234 has a slot 3236 at the interface 13 described above, while the slot bottom 3232 of the third trench forms the slot bottom of the fourth slot segment 3234. The depth of the fourth slot segment 3234 is less than the thickness L of the skin layer to form the third skin layer residual L3 above, and the width of the slot 3236 of the fourth slot segment 3234 is less than or equal to the width of the slot bottom 3235 of the third slot segment 3233. According to an exemplary embodiment, the third groove 323 is continuous from the whole, which facilitates the formation of a third groove 323 while the cover plate/panel/layer 1 is injection molded

According to an exemplary embodiment as shown schematically in FIG. 46, the third groove section 3233 is configured as the area of the notch of the third groove section 3233 greater than the area of the groove bottom 3235. Similar to the second groove 411, during injection molding, the area around the third groove section 3233 is not prone to injection molding defects, which makes the quality of the skin layer 12 formed on the skeleton layer 11 and the form of the outer surface 121 of the skin layer 12 better, which helps to improve the esthetics of the cover plate/panel/layer 1. According to an exemplary embodiment, the cross section of the third slot segment 3233 is generally trapezoidal, and of course may be other suitable shapes. According to an exemplary embodiment, the configuration of the composite structure for the fourth slot segment 3234 is as indicated schematically in the FIGURES.

According to an exemplary embodiment, the width of the notch (i.e. the notch 3231 of the third groove) of the third groove section 3233 is between 3 mm and 5 mm, and the width of the groove bottom 3235 of the third groove section 3233 is between 2 mm and 3 mm. A width of the notch 3236 of the fourth slot 3234 is between 0.2 mm and 0.5 mm. The third slot segment 3233 and the fourth slot segment 3234 of this size facilitate injection molding. According to an exemplary embodiment, the area of the respective apertures and the area of the aperture of the third slot segment 3233 and the fourth slot segment 3234 may be set to other values according to the actual situation.

According to an exemplary embodiment as shown schematically in FIG. 46, the side wall 3237 of the third slot segment 3233 is a smooth sidewall. According to an exemplary embodiment, the sidewall 3219 of the first aperture segment 3211 and the sidewall 3237 of the third slot segment 3233 are different in shape. According to an exemplary embodiment, the configuration of the composite structure helps to avoid injection-molding defects accumulation of the third slot segment 3233 and the first aperture segment 3211 during the injection molding process. According to an exemplary embodiment, the quality of the skin layer 12 formed on the skeleton layer 11 and the form of the outer surface 121 of the skin layer 12 are good, which helps to improve the esthetics of the cover plate/panel/layer 1.

According to an exemplary embodiment as shown schematically in FIG. 47, the extension section 4 comprises a plurality of second holes 421 and a plurality of second grooves 411 arranged in sequence along the longitudinal direction of the extension section 4, and a second groove 411 is connected between adjacent second holes 421 in the present application, and the longitudinal direction of the extension section 4 refers to a direction generally parallel to the length direction of the extension section.

According to an exemplary embodiment as shown schematically in FIG. 48, the second hole 421 extends from the inner surface 111 of the skeleton layer 11 along the thickness direction A of the cover plate/panel/layer 1 into the skin layer 12. According to an exemplary embodiment, the second aperture 421 has an aperture 4216 in the inner surface 111 of the skeleton layer 11 and an aperture bottom 4217 in the aperture bottom 4217 of the skin layer 12 spaced apart from the outer surface 121 of the skin layer 12 forming a fourth skin layer residual L4 between the aperture bottom 4217 of the second aperture 421 and the outer surface 121 of the skin layer 12.

According to an exemplary embodiment as shown schematically in FIG. 49, the second groove 411 extends from the inner surface 111 of the skeleton layer 11 along the thickness direction A of the cover plate/panel/layer 1 into the skeleton layer 11. According to an exemplary embodiment, the second groove 411 has a notch 4111 in the inner surface 111 of the skeleton layer 11 and a groove bottom 4112 of the groove bottom 4112 second groove 411 in the skeleton layer 11 spaced apart from the interface 13 of the skeleton layer 11 and the skin layer 12 forming a second skeleton layer residual S2 between the groove bottom 4112 of the second groove 411 and the interface 13

From the cover plate/panel/layer 1 along the extension segment 4, the second hole 421 penetrates the skeleton layer 11, and the second groove 411 reduces the thickness of the skeleton layer 11, so the strength at the extension segment 4 is small. When the cover plate/panel/layer 1 is impacted by the airbag, the crack formed in the tear-off section 3 is rapidly expanded along the extension section 4, so that the cover plate/panel/layer 1 is quickly split along the weakening line 2. Since the second groove 411 does not penetrate through the skeleton layer 11, the strength at the extension section 4 is greater than the strength at the tear-off section 3. According to an exemplary embodiment, these second holes 421 are spaced apart by the second grooves 411, so that the framework layer 11 still maintains a relatively complete structure at the expansion section 4, which helps to avoid that the overall strength of the cover plate/panel/layer 1 is too small, so as to prevent the cover plate/panel/layer 1 from being accidentally damaged; moreover, the support effect of the skeleton layer 11 on the skin layer 12 is good, so that a weakening mark corresponding to the extension section 4 is not easily generated on the outer surface 121 of the skin layer 12. According to an exemplary embodiment, the fourth skin layer residual L4 is between 0.1 mm and 1 mm, preferably between 0.4 mm and 0.8 mm; the second framework layer residual S2 is between 1 mm and 2 mm, preferably between 1.3 mm and 1.8 mm.

According to an exemplary embodiment, the area of the aperture bottom 4217 of the second aperture 421 is between 0.1 mm and 0.6 mm. According to an exemplary embodiment, the area of the aperture bottom 4217 of the second aperture 421 is smaller. After aging of the skin layer 12, the outer surface 121 of the skin layer 12 is not easy to produce a weakened or weakened footprint corresponding to the second hole 421 helping to improve the esthetics of the cover plate/panel/layer 1.

According to an exemplary embodiment as shown schematically in FIG. 47, each second aperture 421 comprises at least two opposing second apex angles 4218, and the lines between these second apex angles 4218 extend in the longitudinal direction of the extension section 4. The second groove 411 is connected between the opposite second apex angles 4218 of the two adjacent second apertures 421. Similar to the first hole 321 of the peeling section 3, when the cover plate/panel/layer 1 is impacted by the airbag, a large stress concentration is generated at the second vertex angle 4218 of the second hole 421. According to an exemplary embodiment, the configuration of the composite structure facilitates rapid expansion of the crack along the extension segment 4 quickly cracking the cover plate/panel/layer 1. According to an exemplary embodiment, the second hole 421 may be generally a rhombus, and certainly may be other shapes, such as an ellipse.

According to an exemplary embodiment, from the whole of the weakening line 2, both the first hole 321 and the second hole 421 are distributed along the longitudinal direction of the weakening line 2, and the connecting line of the first vertex angle 3218 and the connecting line of the second vertex angle 4218 extend along the longitudinal direction of the corresponding weakening line 2. According to an exemplary embodiment, when the cover plate/panel/layer 1 is impacted by the airbag, the cover plate/panel/layer 1 is split according to a predetermined trajectory (i.e. the weakening line 2), so that the split mode of the cover plate/panel/layer 1 can be controlled, and the spatter can be avoided.

According to an exemplary embodiment as shown schematically in FIG. 48, the second hole 421 comprises a third hole section 4211 and a fourth hole section 4212 through the skeleton layer 11 along the thickness direction A of the cover plate/panel/layer 1, the third hole section 4211 has a hole bottom 4213 at the interface 13 of the skeleton layer 11 and the skin layer 12, and the aperture 4216 of the second hole forms an aperture of the third hole section 4211. The fourth hole section 4212 extends along the thickness direction A of the cover plate/panel/layer 1 from the hole bottom 4213 of the third hole section 4211 into the skin layer 12. According to an exemplary embodiment, the fourth aperture segment 4212 has an aperture 4214 at the interface 13 of the skeleton layer 11 and the skin layer 12, while the aperture bottom 4217 of the second aperture forms the aperture of the fourth aperture segment 4212. The depth of the fourth hole section 4212 is less than the thickness L of the skin layer 12 to form the fourth skin layer residual L4 above, and the area of the aperture 4214 of the fourth hole section 4212 is less than or equal to the area 4213 of the third hole section 4211. According to an exemplary embodiment, the second aperture 421 is continuous from the entirety, which facilitates the formation of the second aperture 421 while the cover panel 1 is injection molded.

According to an exemplary embodiment as shown schematically in FIG. 48, similar to the first aperture segment 3211, the third aperture segment 4211 is configured such that its aperture has an area greater than the area of its aperture bottom 4213. According to an exemplary embodiment, during injection molding, the area around the third hole section 4211 is not prone to injection molding defects, so that the quality of the skin layer 12 formed on the skeleton layer 11 and the form of the outer surface 121 of the skin layer 12 are good, which helps to improve the aesthetics of the cover plate/panel/layer 1. According to an exemplary embodiment, the configuration of the composite structure for the fourth hole section 4212 is as indicated schematically in the FIGURES.

According to an exemplary embodiment, the area of the aperture of the third aperture section 4211 (i.e. the aperture 4216 of the second aperture 421) is between 1.5 mm and 2.2 mm, and the area of the aperture bottom 4213 of the third aperture section 4211 is between 0.4 mm and 0.6 mm. The aperture 4214 of the fourth hole section 4212 has an area of between 0.4 mm and 0.6 mm. The third bore section 4211 and the fourth bore section 4212 of this size facilitate injection molding. According to an exemplary embodiment, the area of the respective orifices of the third hole section 4211 and the fourth hole section 4212 and the area of the hole bottom may be set to other values according to the actual situation.

According to an exemplary embodiment as shown schematically in FIG. 49, the width of the notch 4111 of the second groove 411 is greater than the width of the groove bottom 4112 of the second groove. According to an exemplary embodiment, the cross section of the second groove 411 is generally trapezoidal. During injection molding, the area around the second groove 411 is not prone to injection molding defects, which helps to make the shape of the skin layer 12 formed on the skeleton layer 11 and the form of the outer surface 121 of the skin layer 12 better helping to improve the aesthetics of the cover plate/panel/layer 1. According to an exemplary embodiment, the cross-section of the second trench 411 may be V-shaped or other suitable shape. According to an exemplary embodiment, the width of the notch 4111 of the second groove 411 is between 2.5 mm and 3.5 mm, and the width of the groove bottom 4112 is between 2.5 mm and 3 mm.

In the weakening line of an exemplary embodiment, the extension section 4 may comprise a portion with only the second groove 411, but not the second hole 421. According to an exemplary embodiment, these parts that do not have the second hole 421 are away from the tear-off section 3.

Composite Structure/Cover with Line/Seam-Exemplary Embodiment

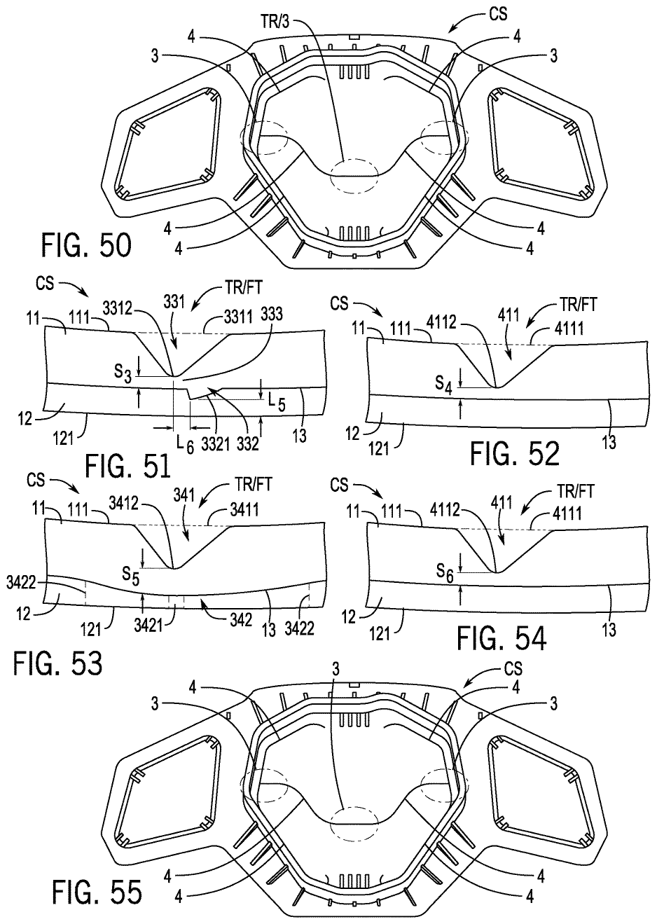

According to an exemplary embodiment as shown schematically in FIGS. 38 and 50, the weakening line of an exemplary embodiment is similar to the weakening line of an exemplary embodiment as a whole, and only the differences between the two are described below.

According to an exemplary embodiment as shown schematically in FIG. 51, the tear-off section 3 of the weakening line 2 of an exemplary embodiment comprises a fifth groove 331 and an inner skin layer 332, and the skin layer inner groove 332 is formed at the interface 13 of the skeleton layer 11 and the skin layer 12.

According to an exemplary embodiment as shown schematically in FIG. 51, the fifth groove 331 extends from the inner surface 111 of the skeleton layer 11 along the thickness direction A of the cover plate/panel/layer 1 to the interior of the skeleton layer 11. According to an exemplary embodiment, the fifth groove 331 has a notch 3311 on the inner surface 111 of the skeleton layer 11 and a groove bottom 3312 of the fifth groove 331 in the skeleton layer 11 spaced apart from the interface 13 forming a third skeleton layer residual S3 between the groove bottom 3312 of the fifth groove 331 and the interface 13

According to an exemplary embodiment as shown schematically in FIG. 51, the skin layer inner groove 332 extends along the thickness direction A of the cover plate/panel/layer 1 to the inner part of the skin layer 12 and is filled by the material of the skeleton layer 11. The skin layer inner groove 332 has a groove bottom 3321 in the skin layer 12 of the groove bottom 3321 skin layer inner groove 332 spaced apart from the outer surface 121 of the skin layer 12 forming a fifth skin layer residual L5 between the groove bottom 3321 of the skin layer inner groove 332 and the outer surface 121 of the skin layer 12, the groove bottom 3321 of the skin layer inner groove 332 being within the range of the orthographic projection of the fifth groove 331 towards the skin layer 12 and offset in the transverse direction W from the groove bottom 3312 of the fifth groove 331, the term “lateral direction” referring to a direction generally perpendicular to the longitudinal direction of the weakening line.

According to this structure, the thickness of the skeleton layer 11 is thinned by the fifth groove 331, and the thickness of the skin layer 12 is reduced by the groove 332 in the skin layer, so the overall thickness at the tear-off section 3 is reduced, and the strength is correspondingly reduced. Moreover, the inner skin layer 332 and the fifth groove 331 are adjacent in the transverse direction W, and the thickness of the connection portion 333 between the two is small, and the strength is small. When the cover plate/panel/layer 1 is impacted by the airbag, the connection portion 333 is easily torn and the skeleton layer 11 and the skin layer 12 are easily torn to create a crack at the tear-off section 3.

According to an exemplary embodiment, the third skeleton layer residual S3 is between 0.2 mm and 1.5 mm; preferably between 0.4 mm and 1 mm. The fifth skin layer residual L5 is between 0.1 mm and 1.5 mm; preferably between 0.4 mm and 1 mm.

According to an exemplary embodiment, since the groove bottom 3321 of the skin layer inner groove 332 is laterally offset from the groove bottom 3312 of the fifth groove 331, along the thickness direction A of the cover plate/panel/layer 1, the skeleton layer 11 has an appropriate thickness corresponding to the skin layer inner groove 332 to better support the corresponding part of the skin layer 12 (i.e. corresponding to the part of the tear-off section 3). According to an exemplary embodiment, the configuration of the composite structure helps to avoid producing a weakened or weakened print on the outer surface 121 of the skin layer 12 that corresponds to the tear-off section 3 improving the appearance quality of the cover plate/panel/layer 1. According to an exemplary embodiment, the lateral distance L6 between the groove bottom 3321 of the skin layer inner groove 332 and the groove bottom 3312 of the fifth groove 331 is between 0.6 mm and 1.5 mm.

According to an exemplary embodiment as shown schematically in FIG. 51, the width of the notch 3311 of the fifth groove 331 is greater than the width of the groove bottom 3312 of the fifth groove 331. According to an exemplary embodiment, the cross section of the fifth groove 331 is generally V-shaped. Similar to the second groove 411, during injection molding, the area around the fifth groove 331 is not prone to injection molding defects, which helps to make the shape of the skin layer 12 formed on the skeleton layer 11 and the form of the outer surface 121 of the skin layer 12 better helping to improve the aesthetics of the cover plate/panel/layer 1. According to an exemplary embodiment, the cross section of the fifth groove 331 may be trapezoidal or other suitable shape. According to an exemplary embodiment, the width of the notch 3311 of the fifth groove 331 is between 6 mm and 8 mm, and the width of the groove bottom 3312 is between 0.2 mm and 0.7 mm.

According to an exemplary embodiment as shown schematically in FIG. 52, the structure of the extension section 4 is similar to the structure of the extension section 4 as shown schematically in FIG. 42, and the two are configured as the second groove 411 in FIG. 17, and the second groove 411 extends from the inner surface 111 of the framework layer 11 along the thickness direction A of the cover plate/panel/layer 1 into the framework layer 11. According to an exemplary embodiment, the second groove 411 has a notch 4111 on the inner surface 111 of the skeleton layer 11 and a groove bottom 4112 of the groove bottom 4112 second groove 411 in the skeleton layer 11 spaced apart from the interface 13 forming a fourth skeleton layer residual S4 between the groove bottom 4112 of the second groove 411 and the interface 13

Similar to the second groove 411 of the weakening line of an exemplary embodiment, the strength at the second groove 411 is small, so that when the cover plate/panel/layer 1 is impacted by the airbag, the crack generated at the tear-off section 3 will rapidly expand along the second groove 411, and finally crack the cover plate/panel/layer 1. According to an exemplary embodiment, since the second groove 411 does not penetrate through the skeleton layer, the part of the skin layer 12 corresponding to the second groove 411 may be well supported by the skeleton layer 11, which makes the outer surface 121 of the skin layer 12 not easy to generate a weakening mark corresponding to the second groove 411 helping to improve the aesthetics of the cover plate/panel/layer 1. According to an exemplary embodiment, the configuration of the composite structure form of the second groove 411 helps to avoid an excessively small overall strength of the cover plate/panel/layer 1 avoiding accidental damage to the cover plate/panel/layer 1. According to an exemplary embodiment, the fourth skeleton layer residual S4 is between 1 mm and 4 mm. According to an exemplary embodiment, the fourth skeleton layer residual S4 is between 2 mm and 3.5 mm.

According to an exemplary embodiment as shown schematically in FIG. 52, a width of the notch 4111 of the second groove 411 is greater than a width of the groove bottom 4112. According to an exemplary embodiment, the cross section of the second groove 411 is generally V-shaped. Similar to the second groove 411 of the weakening line of an exemplary embodiment, this form of second groove 411 helps to improve the quality of the skin layer 12 and the form of the outer surface 121 of the skin layer 12 helping to improve the esthetics of the cover plate/panel/layer 1. According to an exemplary embodiment, the cross section of the second groove 411 may be trapezoidal or other suitable shape. According to an exemplary embodiment, the width of the notch 4111 of the second groove 411 is between 6 mm and 8 mm, and the width of the groove bottom 4112 is greater than 0 and less than or equal to 0.5 mm.

Composite Structure/Cover with Line/Seam-Exemplary Embodiment

According to an exemplary embodiment as shown schematically in FIGS. 38 and 55, the weakening line of an exemplary embodiment is similar to the weakening line of an exemplary embodiment as a whole, and only the differences between the two are described below.

According to an exemplary embodiment as shown schematically in FIG. 53, the tear-off section 3 of the weakening line 2 of an exemplary embodiment includes a seventh groove 341 and a thickness-reducing region 342 of the skin layer extending from the inner surface 111 of the skeleton layer 11 along the thickness direction A of the cover plate/panel/layer 1 to the interior of the skeleton layer 11. According to an exemplary embodiment, the seventh groove 341 has a notch 3411 in the inner surface 111 of the skeleton layer 11 and a groove bottom 3412 of the seventh groove 341 in the groove bottom 3412 within the skeleton layer 11 spaced apart from the interface 13 of the skeleton layer 11 and the skin layer 12 forming a fifth skeleton layer residual S5 between the groove bottom 3412 and the interface 13 of the seventh groove 341

According to an exemplary embodiment as shown schematically in FIG. 55, the thickness thinned region 342 is configured to gradually decrease in width direction W from both ends 3422 to middle 3421 along the width direction W of the weakening line 2. According to an exemplary embodiment, both the inner surface and the outer surface of the thickness thinned region 342 are smooth arcs. The orthographic projection of the seventh groove 341 towards the skin layer 12 is within the range of the thickness reduction zone 432.

According to this configuration, the seventh groove 341 and the thickness thinned area 342 together reduce the thickness at the tear-off section 3, reducing the strength at the tear-off section 3. When the cover plate/panel/layer 1 is impacted by the airbag, a crack is generated at the tear-off section 3. According to an exemplary embodiment, the groove bottom 3412 of the seventh groove 341 is aligned with the middle portion 3421 of the thickness thinned region 342, which helps to attenuate the strength of the tear down segment 3. According to an exemplary embodiment, the seventh groove 341 does not penetrate through the skeleton layer 11, so the part of the skin layer 12 corresponding to the tear-off section 3 will obtain a good support of the skeleton layer 11, which makes it not easy to produce a weakened print corresponding to the tear-off section 3 on the outer surface 121 of the skin layer 12 helping to improve the esthetics of the cover plate/panel/layer 1. According to an exemplary embodiment, the fifth skeleton layer residual S5 is between 1 mm and 3 mm, preferably between 1.3 mm and 2 mm; the thickness of the middle part 3421 of the thickness thinning area 342 is between 0.6 mm and 1 mm.

According to an exemplary embodiment, the thickness of the thickness reduction zone 342 decreases smoothly, there is no significant thickness mutation point, which helps to avoid the generation of a weakened print corresponding to the thickness reduction zone 342 on the outer surface 121 on the skin layer 12; and this form of thickness reduction zone 342 helps to improve the injection molding quality of the skin layer 12, whereby the appearance quality of the cover plate/panel/layer 1 is improved.

According to an exemplary embodiment, the width of the notch 3411 of the seventh groove 341 is greater than the width of the groove bottom 3412 of the seventh groove 341. According to an exemplary embodiment, the cross section of the seventh groove 341 is generally V-shaped. Similar to the second groove 411, during injection molding, the area around the seventh groove 341 is not prone to injection molding defects, which helps to make the shape of the skin layer 12 formed on the skeleton layer 11 and the form of the outer surface 121 of the skin layer 12 better helping to improve the aesthetics of the cover plate/panel/layer 1. According to an exemplary embodiment, the cross section of the seventh groove 341 may be trapezoidal or other suitable shape. According to an exemplary embodiment, the width of the notch 3411 of the seventh groove 341 is between 6 mm and 8 mm, and the width of the groove bottom 3412 is between 0.2 mm and 0.7 mm.

According to an exemplary embodiment as shown schematically in FIG. 54, the structure of the extension section 4 is similar to the structure of the extension section 4 shown schematically in FIG. 42, the two are configured as the second groove 411 in FIG. 54, and the second groove 411 extends from the inner surface 111 of the framework layer 11 along the thickness direction A of the cover plate/panel/layer 1 into the framework layer 11. According to an exemplary embodiment, the second groove 411 has a notch 4111 on the inner surface 111 of the skeleton layer 11 and a groove bottom 4112 of the groove bottom 4112 second groove 411 in the skeleton layer 11 spaced apart from the interface 13, so that a sixth skeleton layer residual S6 is formed between the groove bottom 4112 of the second groove 411 and the interface 13 similar to the seventh groove 341, and the second groove 411 does not penetrate through the skeleton layer 11, so that a weakened imprint corresponding to the second groove 411 is not prone to occur on the outer surface 121 of the skin layer 12. According to an exemplary embodiment, the sixth skeleton layer residual S6 is between 2 mm and 4 mm, preferably between 2.5 mm and 3.5 mm

According to an exemplary embodiment as shown schematically in FIG. 54, the width of the notch 4111 of the second groove 411 is greater than the width of the groove bottom 4112 of the second groove 411. According to an exemplary embodiment, the cross section of the second groove 411 is generally V-shaped. Similar to the seventh groove 341, during injection molding, the area around the second groove 411 is not prone to injection molding defects, which helps to make the shape of the skin layer 12 formed on the skeleton layer 11 and the form of the outer surface 121 of the skin layer 12 better helping to improve the aesthetics of the cover plate/panel/layer 1. According to an exemplary embodiment, the cross section of the second groove 411 may be trapezoidal or other suitable shape. According to an exemplary embodiment, the width of the notch 4111 of the second groove 411 is between 6 mm and 8 mm, and the width of the groove bottom 4112 is greater than 0 and less than or equal to 0.5 mm.

According to an exemplary embodiment, the cover plate/panel/layer 1 includes a surface modification layer (not shown in the figure). The surface modification layer is on the outer surface 121 of the skin layer 12. The surface modification layer may cause the cover plate/panel/layer 1 to exhibit a special visual effect, such as matte, which helps to hide the weakened imprint formed on the outer surface 121 of the skin layer 12. According to an exemplary embodiment, the surface modification layer protects the skin layer 12 to avoid rapid wear of the skin layer 12. According to an exemplary embodiment, the material of the surface modification layer is TPEE (i.e. a thermoplastic polyester elastomer) with a thickness of between 50 μm and 100 μm.

According to an exemplary embodiment as shown schematically in the FIGURES, a cover plate/panel/layer of an airbag may comprise a skeleton layer and a skin layer; the skin layer may be on an outer surface of the skeleton layer and may be integrated with the skeleton layer; a weakening line may be configured on the cover plate/panel/layer; a strength of the weakening line may be less than that of other parts of the cover plate/panel/layer; the weakening line may comprise at least one tear-off section and at least one extension section connected to the tear-off section; the strength of the tear-off section may be less than the strength at the extension section. A cover plate/panel/layer of an airbag may comprise a skeleton layer and a skin layer on an outer surface of the skeleton layer; the cover plate/panel/layer may be formed by double-color injection molding; a material of a first shot in the double-color injection molding may be used to form one of the skeleton layer and the skin layer; a material of a second shot may be used to form the other of the skeleton layer and the skin layer; the airbag cover plate/panel/layer may comprise a weakening line configured on the cover plate/panel/layer; the strength of the weakening line may be less than the strength of other portions of the cover plate/panel/layer; the weakening line may be formed by injection molding with the skeleton layer and/or the skin layer; the weakening line may comprise at least one tear-off section and at least one extension section connected to the tear-off section the strength of the tear-off section may be less than the strength at the extension section; there may be a plurality of tearing segments and a plurality of extension segments; the plurality of extension segments may be spaced apart by the plurality of tearing segments; the weakening line may comprise two first weakening lines arranged opposite to each other and spaced apart; each of the first weakening lines may comprise a first middle section and two first extension sections respectively located on two sides of the first middle section; the weakening line may comprise at least one second weakening line between the two first weakening lines; the second weakening line may comprise a second middle section, two end sections, and two second extension sections; each of the second extension sections may be connected to the second middle section and the corresponding end section; the two end sections may be respectively connected to the two corresponding first middle sections; the tear-off section may comprise two first middle sections, two end sections, and the second middle section; and the extension section may comprise two first extension sections and two second extension sections; the tear-off section may be configured as a first groove; the first groove may extend from an inner surface of the skeleton layer into the skin layer along a thickness direction of the cover plate/panel/layer; a groove bottom of the first groove may be spaced apart from an outer surface of the skin layer to form a first skin layer residual between a groove bottom of the first groove and an outer surface of the skin layer; a residual thickness of the first skin layer may be between 0.1 mm and 1 mm; a width of the groove bottom of the first groove may be greater than 0 and less than or equal to 0.2 mm; the first groove may comprise a first groove section penetrating through the skeleton layer in a thickness direction of the cover plate/panel/layer and a second groove section extending from a groove bottom of the first groove section into the skin layer along a thickness direction of the cover plate/panel/layer; a depth of the second groove section may be less than a thickness of the skin layer; a notch width of the second groove section may be less than or equal to a groove bottom width of the first groove section; a width of a notch of the first groove section may be greater than a width of a groove bottom of the first groove section and/or a notch width of the second groove section may be greater than a groove bottom width of the second groove section; an interface may exist between the skeleton layer and the skin layer; the extension section may comprise a second groove extending from an inner surface of the skeleton layer into the skeleton layer along a thickness direction of the cover plate/panel/layer; a groove bottom of the second groove may be spaced apart from the interface; the second groove may be configured to have a notch width greater than a groove bottom width; the tear-off section may comprise a plurality of first holes arranged in sequence along a longitudinal direction of the tear-off section and a third groove connected between adjacent first holes; the first hole may extend from an inner surface of the skeleton layer into the skin layer along a thickness direction of the cover plate/panel/layer; a hole bottom of the first hole may be spaced apart from an outer surface of the skin layer to form a second skin layer residual between the hole bottom of the first hole and the outer surface of the skin layer; the third groove may extend from an inner surface of the skeleton layer into the skin layer along a thickness direction of the cover plate/panel/layer; a groove bottom of the third groove may be spaced apart from an outer surface of the skin layer to form a third skin layer residual between a groove bottom of the third groove and an outer surface of the skin layer; a residual thickness of the third skin layer may be greater than a residual thickness of the second skin layer; a residual thickness of the second skin layer may be between 0.1 mm and 1 mm and a residual thickness of the third skin layer may be between 0.5 mm and 1.5 mm; an area of the hole bottom of the first hole may be between 0.1 mm and 0.6 mm and a width of the groove bottom of the third groove may be greater than 0 and less than or equal to 0.2 mm; each of the first holes may comprise at least two opposite first vertex angles; a connecting line between the first vertex angles may extend longitudinally along the tear-off section; the third groove may be connected between opposite first vertex angles of two adjacent first holes; the first hole may comprise a first hole section penetrating through the skeleton layer in a thickness direction of the cover plate/panel/layer and a second hole section extending from a hole bottom of the first hole section into the skin layer along a thickness direction of the cover plate/panel/layer; a depth of the second hole section may be less than a thickness of the skin layer; an aperture area of the second hole section may be less than or equal to a hole bottom area of the first hole section; an aperture area of the first hole section may be greater than a hole bottom area of the first hole section and/or an aperture area of the second hole section may be greater than a hole bottom area of the second hole section; the side wall of the first hole section may be configured to be stepped; the third groove may comprise a third groove section and a fourth groove section; the third groove section may penetrate through the skeleton layer in a thickness direction of the cover plate/panel/layer; the fourth groove section may extend from a groove bottom of the third groove into the skin layer along a thickness direction of the cover plate/panel/layer; a depth of the fourth groove section may be less than a thickness of the skin layer; a notch width of the fourth groove section may be less than or equal to a groove bottom width of the third groove section; a notch width of the third groove section may be greater than a groove bottom width of the third groove section and/or a notch width of the fourth groove section may be greater than a groove bottom width of the fourth groove section; a side wall of the third groove section may be a smooth side wall; the extension section may comprise a plurality of second holes and a plurality of second grooves; the plurality of second holes may be arranged in sequence along a longitudinal direction of the extension section; one second groove may be connected between adjacent second holes; the second hole may extend from an inner surface of the skeleton layer into the skin layer along a thickness direction of the cover plate/panel/layer; a hole bottom of the second hole may be spaced apart from an outer surface of the skin layer to form a fourth skin layer residual between the hole bottom of the second hole and the outer surface of the skin layer; a residual thickness of the fourth skin layer may be between 0.1 mm and 1 mm; a hole bottom area of the second hole may be between 0.1 mm and 0.6 mm; each of the second holes may comprise at least two opposite second vertex angles; a connection line between the second vertex angles may extend along a longitudinal direction of the extension segment; the second groove may be connected between opposite second vertex angles of two adjacent second holes; the second hole may comprise a third hole section and a fourth hole section; the third hole section may penetrate through the skeleton layer in a thickness direction of the cover plate/panel/layer; the fourth hole section may extend from a hole bottom of the third hole section into the skin layer along a thickness direction of the cover plate/panel/layer; a depth of the fourth hole section may be less than a thickness of the skin layer; an aperture area of the fourth hole section may be less than or equal to a hole bottom area of the third hole section; an aperture area of the third hole section may be greater than a hole bottom area of the third hole section and/or an aperture area of the fourth hole section may be greater than a hole bottom area of the fourth hole section; the tear-off section may comprise a fifth groove and a groove bottom of the fifth groove; the fifth groove may extend from an inner surface of the skeleton layer to an interior of the skeleton layer along a thickness direction of the cover plate/panel/layer; a groove bottom of the fifth groove may be spaced apart from an interface of the skeleton layer and the skin layer; a skin layer inner groove may be formed at the interface; the skin layer inner groove may extend into the skin layer along a thickness direction of the cover plate/panel/layer and may be filled by a material of the skeleton layer; a groove bottom of the skin layer inner groove may be spaced apart from an outer surface of the skin layer to form a fifth skin layer residual thickness between a groove bottom of the skin layer inner groove and an outer surface of the skin layer; a groove bottom of the skin layer inner groove may be in a range of an orthographic projection of the fifth groove facing the skin layer and may deviate from a groove bottom of the fifth groove; a residual thickness of the fifth skin layer may be between 0.1 mm and 1.5 mm; a transverse distance between a groove bottom of the skin layer inner groove and a groove bottom of the fifth groove may be between 0.6 mm and 1.5 mm; the fifth groove may be configured to have a slot width greater than a groove bottom width; the tear-off section may comprise a seventh groove, a groove bottom of the seventh groove and a reduced thickness area formed in the skin layer; the seventh groove may extend from an inner surface of the skeleton layer to an interior of the skeleton layer along a thickness direction of the cover plate/panel/layer; the groove bottom of the seventh groove may be spaced apart from an interface of the skeleton layer and the skin layer; the reduced thickness area may be configured to gradually decrease in a width direction of the weakening line from two ends to a middle thickness; an orthographic projection of the seventh groove facing the skin layer may be within a range of the reduced thickness area; a thickness of a middle portion of the reduced thickness area may be between 0.6 mm and 1 mm; a thickness of the reduced thickness area may decrease smoothly from two ends to a middle in a width direction of the weakening line; a bottom of the seventh groove may be directly opposite to a middle portion of the reduced thickness area; the seventh groove may be configured to have a slot width greater than a groove bottom width; the cover plate/panel/layer of the airbag may comprise a surface modification layer located on an outer surface of the skin layer; a vehicle steering wheel may comprise a cover plate/panel/layer of the airbag.

### EXEMPLARY EMBODIMENTS—D

According to an exemplary embodiment, a composite structure such as comprising a cover plate/panel/layer may be configured with body and a skin to satisfy the strength requirements and achieve aesthetics objectives for the component/product. According to an exemplary embodiment as indicated schematically in the FIGURES, the cover plate/panel/layer of the airbag comprises a skeleton layer and a skin layer. The skin layer is located on the outer surface of the skeleton layer and is integrated with the skeleton layer. A weakening line is constructed on the cover plate/panel/layer, and the strength of the weakening line is less than that of other portions of the cover plate/panel/layer; the weakening line comprises at least one tearing section and at least one extension section connected to the tearing section, and the strength of the tearing section is less than that of the extension section. According to the cover plate/panel/layer of the airbag, the skeleton layer and the skin layer are integrally formed. During the manufacturing of the cover plate/panel/layer, the covering operation of skin is not needed, which helps to reduce the manufacturing costs of the cover plate/panel/layer.

According to an exemplary embodiment as indicated schematically in the FIGURES, the existing steering wheel cover may comprise genuine leather or leatherette, and the skin covering takes a long time to cover. Due to the needs of airbag deployment, it is generally weakened on the cover by cold knife weakening or laser weakening. If the weakening is improper, after a long period of high temperature and sun roasting in the car, weakening marks will appear affecting the appearance; a possibility of fragmentation may exist.

According to an exemplary embodiment as indicated schematically in the FIGURES, the feel of leather coating is achieved through the injection molding skin process with surface appearance to satisfy needs of airbag deployment without weakening marks and achieve different tactile sensations according to the tactile needs of different areas. A special coating can achieve the depth and thickness of the leather grain that the current injection molding driver airbag cover cannot achieve.

### EXEMPLARY EMBODIMENTS—E

FIG. 37A schematically indicates a composite structure for a component comprising a cover plate/panel/layer of an airbag according to an embodiment of the present application.

FIG. 37B schematically indicates a composite structure for a component comprising the framework layer and the skin layer of the cover plate/panel/layer of the airbag.

FIG. 38 schematically indicates a composite structure for a component comprising a weakening line of an exemplary embodiment.

FIGS. 39, 39A and 39B schematically show a tear-off section of the weakening line of an exemplary embodiment. FIG. 40 is a cross-sectional view of the tear-off section shown in FIGS. 39, 39A and 39B.

FIG. 41 schematically indicates a composite structure for a component comprising an expanded section of the weakening line of an exemplary embodiment. FIG. 42 is a cross-sectional view of the expanded section shown in FIG. 41. FIG. 43 schematically indicates a composite structure for a component comprising the weakening line of an exemplary embodiment. FIG. 44 is a partial enlarged view of a tear-off section of the weakening line shown in FIG. 43. FIG. 45 is a cross-sectional view of the first hole in the tear-off section shown in FIG. 44. FIG. 46 is a cross-sectional view of a third groove in the tear-off section shown in FIG. 44. FIG. 47 is an enlarged view of a portion of the extended section of the weakening line shown in FIG. 43. FIG. 48 is a cross-sectional view of the second hole in the expanded section shown in FIG. 47. FIG. 49 is a cross-sectional view of the second groove in the expanded section shown in FIG. 47.

FIG. 50 schematically indicates a composite structure for a component comprising a weakening line of an exemplary embodiment.

FIG. 51 schematically indicates a composite structure for a component comprising a cross-sectional view of a tear-off section of the weakening line of an exemplary embodiment.

FIG. 52 schematically indicates a composite structure for a component comprising a cross-sectional view of an expanded section of the weakening line of an exemplary embodiment.

FIG. 53 schematically indicates a composite structure for a component comprising a cross-sectional view of a tear-off section of the weakening line of an exemplary embodiment.

FIG. 54 schematically indicates a composite structure for a component comprising a cross-sectional view of an expanded section of the weakening line of an exemplary embodiment.

FIG. 55 schematically indicates a composite structure for a component comprising a weakening line of an exemplary embodiment.

TABLE A
REFERENCE SYMBOL LIST

| REFERENCE | |
|---|---|
| SYMBOL | ELEMENT, PART OR COMPONENT |
| V | Vehicle |
| VI | Vehicle interior |
| C | Component |
| | (e.g. door panel, floor console, instrument panel, |
| | overhead console, overhead panel, pillar, steering |
| | wheel, seat/seat assembly, visor/vanity, etc.) |
| CS | Composite structure |
| T | Cover |
| TB | Base layer |
| | (e.g. cover substrate, base, substrate, structure, skeleton/ |
| | structure, etc.) |
| TX | Cover layer |
| | (e.g. cover skin, skin, skin layer, etc.) |
| TC | Cover/surface layer |
| | (e.g. coating, film, etc.) |
| SB | Substrate |
| | (e.g. base layer, base, etc.) |
| TR | Line |
| | (e.g. tear line, seam, weakened line, weakening line, |
| | groove, trench, slot, notch, etc.) |
| FT | Feature |
| | (e.g. recess, groove, aperture, hole, etc.) |
| GR | Groove |
| | (e.g. seam, line, recess, trench, section, segment, slot, |
| | notch, etc.) |
| SW | Steering Wheel/assembly |
| HN | User interface module |
| | (e.g. horn module, etc.) |
| RM | Armature/frame |
| AB/ABX | Airbag |
| ABD | Airbag door |
| ABM | Airbag module |
| CH | Housing/chute |
| | (e.g. airbag chute, etc.) |
| 1 | Composite structure |
| | Airbag cover plate/panel/layer |
| 11 | Inner surface of the skeleton layer |
| 111 | Skeleton layer |
| 12 | Outer surface of the skin layer |
| 121 | Cover layer |
| | Skin layer |
| 13 | Intermediate layer |
| | Interface |
| 14 | Span |
| 2 | Line/weakened area |
| | Weakening line |
| 201 | First weakening line |
| 202 | Second weakening line |
| 203 | First middle section |
| 204 | First extension section |
| 205 | Second middle section |
| 206 | End section |
| 207 | Second extension section |
| 3 | Tear line/weakened area |
| | Tear segment |
| 31 | Groove bottom of first groove |
| 313 | First groove |
| 311 | First slot section |
| 3112 | Width of the groove bottom |
| 3111 | Width of the notch |
| 312 | Second slot section |
| 3121 | Notch of second slot section |
| 321 | First hole |
| 3211 | First bore segment |
| 3212 | Second bore segment |
| 3213 | Aperture bottom |
| 3214 | Aperture |
| 3216 | Aperture |
| 3217 | Aperture bottom |
| 3218 | Opposite first vertex angles |
| 3219 | Side wall |
| 323 | Third trench |
| 3231 | Groove bottom of third groove |
| 3232 | Notch of third groove |
| 3233 | Third slot segment |
| 3234 | Fourth slot segment |
| 3235 | Groove bottom |
| 3236 | Slot |
| 3237 | Side wall of the third slot section |
| 331 | Fifth groove |
| 3311 | Groove bottom of fifth groove |
| 332 | Skin layer inner groove |
| 3321 | Groove bottom of the inner groove of the skin layer |
| 333 | Connecting parts between the groove bottom of the fifth |
| | groove and the groove bottom of the inner groove of the |
| | skin layer |
| 341 | Seventh groove |
| 3411 | Groove bottom of the seventh groove |
| 3412 | Notch of the seventh groove |
| 342 | Thickness thinning zone of skin layer |
| 3421 | Middle portion |
| 4 | Extension segment |
| 411 | Second trench |
| 4111 | The groove bottom of the second groove of the notch |
| | of the second groove |
| 4112 | Notch of the second groove |
| 421 | Second hole |
| 4211 | Third hole section |
| 4212 | Fourth hole section |
| 4213 | Aperture of the fourth aperture segment of the aperture |
| | bottom of the third aperture segment |
| 4214 | Aperture bottom of the third aperture segment |
| 4216 | Aperture |
| 4217 | Aperture bottom |
| 4218 | Second vertex angle |
| L | Thickness of the skin layer |
| L1 | First skin layer residual |
| L2 | Second skin layer residual |
| L3 | Third skin layer residual |
| L4 | Fourth skin layer residual |
| L5 | Fifth skin layer residual |
| L6 | Sixth skin layer residual |
| S | Thickness of the skeleton layer |
| S1 | First skeleton layer residual |
| S2 | Second skeleton layer residual |
| S3 | Third skeleton layer residual |
| S4 | Fourth skeleton layer residual |
| S5 | Fifth skeleton layer residual |
| S6 | Sixth skeleton layer residual |
| A | direction |
| W | Transverse direction |

It is important to note that the present inventions (e.g. inventive concepts, etc.) have been described in the specification and/or illustrated in the FIGURES of the present patent document according to exemplary embodiments; the embodiments of the present inventions are presented by way of example only and are not intended as a limitation on the scope of the present inventions. The construction and/or arrangement of the elements of the inventive concepts embodied in the present inventions as described in the specification and/or illustrated in the FIGURES is illustrative only. Although exemplary embodiments of the present inventions have been described in detail in the present patent document, a person of ordinary skill in the art will readily appreciate that equivalents, modifications, variations, etc. of the subject matter of the exemplary embodiments and alternative embodiments are possible and contemplated as being within the scope of the present inventions; all such subject matter (e.g. modifications, variations, embodiments, combinations, equivalents, etc.) is intended to be included within the scope of the present inventions. It should be noted that various/other modifications, variations, substitutions, equivalents, changes, omissions, etc. may be made in the configuration and/or arrangement of the exemplary embodiments (e.g. in concept, design, structure, apparatus, form, assembly, construction, means, function, system, process/method, steps, sequence of process/method steps, operation, operating conditions, performance, materials, composition, combination, etc.) without departing from the scope of the present inventions; all such subject matter (e.g. modifications, variations, embodiments, combinations, equivalents, etc.) is intended to be included within the scope of the present inventions. The scope of the present inventions is not intended to be limited to the subject matter (e.g. details, structure, functions, materials, acts, steps, sequence, system, result, etc.) described in the specification and/or illustrated in the FIGURES of the present patent document. It is contemplated that the claims of the present patent document will be construed properly to cover the complete scope of the subject matter of the present inventions (e.g. including any and all such modifications, variations, embodiments, combinations, equivalents, etc.); it is to be understood that the terminology used in the present patent document is for the purpose of providing a description of the subject matter of the exemplary embodiments rather than as a limitation on the scope of the present inventions.

It is important to note that according to exemplary embodiments the present inventions may comprise conventional technology (e.g. as implemented and/or integrated in exemplary embodiments, modifications, variations, combinations, equivalents, etc.) or may comprise any other applicable technology (present and/or future) with suitability and/or capability to perform the functions and processes/operations described in the specification and/or illustrated in the FIGURES. All such technology (e.g. as implemented in embodiments, modifications, variations, combinations, equivalents, etc.) is considered to be within the scope of the present inventions of the present patent document.

The invention claimed is:

1. A component configured to facilitate formation of an opening for deployment of an airbag into an interior of a vehicle comprising:
a composite structure comprising a cover comprising a base layer and a cover layer;
wherein the composite structure comprises a line at a weakened area for the cover;
wherein the line is configured to facilitate formation of the opening at the weakened area for the cover;
wherein the line comprises a set of features configured to facilitate formation of the opening through the cover;
wherein each feature of the set of features comprises a profile.

2. The component of claim 1 wherein each feature comprises a recess comprising the profile in the cover; wherein the profile of the recess is at least partially formed into the base layer of the cover.

3. The component of claim 1 wherein the line comprises a seam and/or a tear line and/or a seam line and/or weakening line and/or a set of sections and/or a set of segments.

4. The component of claim 1 wherein the line comprises a set of groove sections and the set of features; wherein each feature of the set of features comprises a recess adjacent to a groove section of the set of groove sections.

5. The component of claim 1 wherein the set of features comprises a pattern of features formed in the cover; wherein the pattern of features is configured to form the line in the cover as a weakening line at the weakened area.

6. The component of claim 1 wherein the set of features comprises a pattern of recesses in the cover; wherein the line comprises a tear line in the cover provided by the pattern of recesses.

7. The component of claim 1 wherein the set of features comprises a pattern of recesses formed in the cover; wherein the line comprises a tear line formed in the cover by the pattern of recesses.

8. The component of claim 1 wherein the line comprises a groove in the base layer of the cover; wherein the groove of the line comprises a profile; wherein the profile of the groove of the line comprises a U-shaped profile and/or a V-shaped profile and/or a multi-section profile.

9. The component of claim 1 wherein the profile of a feature of the set of features comprises a uniform-section profile and/or a multi-section profile and/or a tapered profile and/or a sloped section and/or a tip comprising a point and/or a tip at a closed section and/or a trapezoidal shaped profile and/or a U-shaped profile.

10. The component of claim 1 wherein each feature comprises a recess; wherein the profile of the recess comprises an open section and a closed section.

11. The component of claim 1 wherein the profile of each feature comprises an open section formed into the base layer and a closed section at least partially formed into the base layer.

12. The component of claim 1 wherein the profile of each feature comprises an open section formed into the base layer and a closed section at least partially formed into the cover layer.

13. The component of claim 1 wherein line comprises a set of groove sections; wherein a profile of each groove section of the set of groove sections of the line comprises a shape; wherein the profile of each feature of the set of features of the line comprises a shape different than the shape of the profile of each groove section of the set of groove sections of the line.

14. The component of claim 1 wherein the composite structure comprises a surface layer on the cover layer; wherein the surface layer comprises a film and/or a coating and/or an applied coating.

15. The component of claim 1 wherein the base layer comprises an injection-molded substrate for the cover; wherein the cover layer is formed on the base layer.

16. The component of claim 1 wherein the cover layer comprises a molded material formed on the base layer.

17. The component of claim 1 wherein the feature comprises a pattern of recesses configured to form the line as a weakening line at the weakened area for the cover; wherein each recess of the pattern of recesses has a generally V-shaped profile formed into the cover to provide the weakening line at the weakened area for the cover.

18. The component of claim 1 wherein the feature comprises a set of recesses; wherein the line comprises a set of groove sections; wherein a recess of the set of recesses is coupled to a groove section of the set of groove sections to provide the line as a weakening line at the weakened area of the cover.

19. The component of claim 1 wherein the cover is configured to provide a surface effect at an exterior surface of the cover layer; wherein the surface effect comprises a tactile effect and/or a texture effect and/or a color effect and/or a visual effect and/or a decorative effect and/or a protective effect and/or a concealment effect with the line generally visually imperceptible at the exterior surface.

20. The component of claim 1 further comprising a steering wheel assembly and/or a trim component and/or a trim panel and or a trim panel for a steering wheel assembly; wherein the composite structure comprises an airbag chute and an airbag module comprising the airbag.
